(19) United States
(12) Patent Application Publication
(10) Pub. No.: US 2026/0357359 A1
(43) Pub. Date: Nov. 12, 2026

(54) RECUPERATIVE WASTE HEAT RECOVERY SYSTEM AND METHOD FOR HIGH-TEMPERATURE SOLID SLAG PARTICLES

(71) Applicant: Baoshan Iron & Steel Co., Ltd., Shanghai (CN)

(72) Inventors: Yongli Xiao, Shanghai (CN); Yongqian Li, Shanghai (CN); Yunze Guan, Shanghai (CN); Yingjie Wang, Shanghai (CN); Youping Zhang, Shanghai (CN)

(21) Appl. No.: 19/137,637

(22) PCT Filed: Dec. 13, 2023
(86) PCT No.: PCT/CN2023/138513

§ 371 Date: Jun. 10, 2025

(30) Foreign Application Priority Data
Dec. 13, 2022 (CN) 202211603954.2
Dec. 13, 2022 (CN) 202211604005.6
Dec. 13, 2022 (CN) 202211604044.6
Dec. 13, 2022 (CN) 202211604066.2
Dec. 13, 2022 (CN) 202211614584.2
Dec. 13, 2022 (CN) 202223348526.8
Dec. 13, 2022 (CN) 202223348531.9

(51) Int. Cl. C21B 3/08

(52) U.S. Cl. CPC C21B 3/08; C21B 2400/024; C21B 2400/026; C21B 2400/056; C21B 2400/074; C21B 2400/08

(57) ABSTRACT

The present invention discloses a recuperative waste heat recovery system for high-temperature solid slag particles, which comprises: a granulating device (11), the granulating device (11) is preferably a gas-quenching granulating device, a gas-water granulating device or a rotary cup granulating device; a recuperative heat exchanger (12), which comprises a slag particle inlet (1213) corresponding to a slag outlet (1112) of the granulating device (11), a slag particle outlet (1214), and a heat exchange tube set (123) located inside the recuperative heat exchanger (12), the heat exchange tube set (123) has a cooling medium inlet (1211) and a cooling medium outlet (1212), and the cooling medium is preferably water; and a waste heat recovery equipment, the cooling medium inlet (1211) and the cooling medium outlet (1212) are respectively connected to the waste heat recovery equipment through pipelines. The waste heat recovery equipment does not use an intermediate heat transfer medium and has the advantages of high heat exchange efficiency and high heat recovery efficiency.

### TECHNICAL FIELD

The present invention relates to waste heat recovery technology, particularly to a recuperative waste heat recovery system and method for high-temperature solid slag particles.

### BACKGROUND

In the context of contemporary societal development, the iron and steel industry is a fundamental industry in China, which ensures the development of the economy and the construction of basic livelihoods. However, it is also a major contributor of energy consumption and pollution emissions. After research, it was found that the waste heat resources in steel production account for 60% of the total energy consumption of steel production, and are mainly stored in products, blast furnace slag, waste materials, and steel slag. In China, the tapping temperature of blast furnace slag is between 1400-1550 °C, and each ton of slag contains (1260-1880)×10⁶ J of sensible heat, which is equivalent to the calorific value of 60 kg standard coal. After granulation, its temperature remains at least 200-900 °C, preferably 300-800 °C. Therefore, the research and development of high-temperature slag waste heat recovery technology have great significance for energy conservation and emission reduction in the steel industry.

The heat exchange process of high-temperature slag waste heat recovery technology mainly comprises: granulating process of high-temperature molten slag and the high-temperature slag particle waste heat recovery process after granulating; and the process of treating the cooling medium after recovering heat. The methods for recovering waste heat from high-temperature slag particles include: gas-solid direct contact heat exchange, liquid-solid direct contact heat exchange, indirect contact heat exchange, etc. Cooling mediums include water, air, etc. However, research and development on large capacity slag treatment is not sufficient, and there is still a problem of thermal energy squandering.

### SUMMARY

In view of the above-mentioned technical problems, the objective of the present invention is to propose a recuperative waste heat recovery system for high-temperature solid slag particles, and its heat transfer process comprises: direct contact heat exchange between air and slag particles and indirect contact heat exchange between water/steam and slag particles, improving the thermal recovery efficiency of high-temperature solid slag particles.

For achieving the above-mentioned objective, the technical solution of the present invention is as follows:

A recuperative waste heat recovery system for high-temperature solid slag particles, comprising:
a granulating device, the granulating device is preferably a gas-quenching granulating device, a gas-water granulating device, or a rotary cup granulating device;
a rolling recuperative heat exchanger, the recuperative heat exchanger comprises a slag particle inlet corresponding to a slag outlet of the granulating device, a slag particle outlet, and a heat exchange tube set located inside the recuperative heat exchanger, the heat exchange tube set has a cooling medium inlet and a cooling medium outlet, and the cooling medium is preferably water; and
a waste heat recovery equipment, wherein the cooling medium inlet and the cooling medium outlet are respectively connected to the waste heat recovery equipment through pipelines.

The waste heat recovery equipment is used to store the heat recovered from high-temperature slag particles and further utilize it according to subsequent settings.

Preferably, the waste heat recovery equipment comprises:
a steam drum, the steam drum comprises a steam drum water inlet, a steam drum water outlet, a saturated steam outlet, and a steam-water mixture inlet;
a water tank;
wherein the steam drum water inlet is connected to the water tank, the cooling medium inlet is connected to the steam drum water outlet, and the cooling medium outlet is connected to the steam-water mixture inlet.

The pipeline system separates saturated water and saturated steam in the steam drum, and then the saturated steam (about 180 °C) can be used by downstream users, such as for supplying heating of buildings or low-pressure boilers. The water tank is used to replenish water to the steam drum, so that the water level in the steam drum maintains constant after the steam is discharged out.

Preferably, the recuperative waste heat recovery system for high-temperature solid slag particles further comprises a conveyor and a dust collector arranged below the slag particle outlet, wherein an inlet end of the dust collector is connected to an air outlet of the recuperative heat exchanger through a pipeline, and an outlet of the dust collector is connected to the waste heat recovery equipment through a pipeline.

After the slag particles is performed heat exchange with the heat exchange tube set, the additional heat of the slag particles can be further diffused to the waste heat recovery equipment through a pipeline. Preferably, the heat exchanger comprises a cylinder, the slag particle inlet and the slag particle outlet are respectively set at the upper end and bottom of the cylinder, the upper part of one side wall of the cylinder is arranged with an air outlet, and the lower part of the other side wall is arranged with an air inlet pipeline and a fan; preferably, a guide plate that guides the uniform flow of slag particles is arranged at the upper part of the cylinder; preferably, the lower part of the cylinder is equipped with an air distribution equipment.

By air distribution equipment, the diffusion of slag particle heat through the pipeline can be accelerated, and the process of heat transfer to the waste heat recovery equipment can be accelerated.

Preferably, the heat exchanger comprises a cylinder of a metal shell-and-tube structure, and the slag particle inlet and slag particle outlet are respectively arranged on a side wall of the cylinder on the cooling medium outlet side and a side wall of the cylinder on the cooling medium inlet side, spiral plates with interconnected through-holes are arranged inside the cylinder, and the heat exchange tubes are inserted into the through-holes; preferably, an outer shell of the cylinder adopts a water-cooled wall structure, comprising a cylinder heat exchange tube sleeve, a core-shaft heat exchange tube, a spiral plate arranged inside cylinder, and a heat exchange tube set passing through the spiral plates.

Adopting a spiral plate heat exchange device similar to a rolling bed can achieve rapid cooling (not less than 20 °C/min) of high-temperature slag particles while generating saturated steam.

Preferably, the heat exchanger is a metal shell-and-tube structure, whose internal structure is divided into a superheating section and a vaporization section vertically from top to bottom, a first heat exchange tube set and a second heat exchange tube set are respectively arranged in superheating section and vaporization section, wherein an inlet end of the first heat exchange tube set is connected to a saturated steam outlet of the steam drum, and an outlet end of first heat exchange tube set is connected to a steam pipe network through a pipeline via a buffer tank, an inlet end of the second heat exchange tube set is connected to a saturated water outlet of the steam drum, and an outlet end of the second heat exchange tube is connected to a saturated steam-water mixture inlet of the steam drum, the heat exchanger is provided with guide plates arranged vertically at intervals and a material distributing chute located below the slag material inlet, and through-holes for heat exchange tubes to pass through are arranged on the guide plates.

The guide plates provide effective support for the heat exchange tube set and avoid deflected flow of slag particles, making the flowing of slag particles in all areas uniform and consistent. The material distributing chute can rotate 360 degrees and pitch up and down within the range of 0-90 degrees (0 degree represents the horizontal placement and 90 degrees represent the vertical placement). When distributing material, the chute can uniformly distribute high-temperature slag particles by rotating and pitching motion.

Preferably, the recuperative waste heat recovery system for high-temperature solid slag particles further comprises a disturbance rod inserted between the first heat exchange tube and the second heat exchange tube in the heat exchanger with one end of the disturbance rod fixed to a fixed base and the other end of the disturbance rod extending out the heat exchanger; disturbance arms are arranged at intervals in the axial direction on rod body of disturbance rod, and an axis of the disturbance arm and an axis of the disturbance rod forms an angle; preferably, adjacent disturbance arms are installed in an anti-symmetric manner;
a drive device, with an output end of the drive device connected to the end of the disturbance rod extending out the heat exchanger.

By the action of the disturbance rod and its disturbance arms, clogging of the slag particles between the heat exchange tubes can be prevented.

Preferably, the drive device is of a worm and worm wheel type, wherein the worm wheel is coaxially connected to the end of the disturbance rod.

Preferably, the recuperative waste heat recovery system for high-temperature solid slag particles further comprises at least one high-temperature storage tank arranged between the granulating device and the recuperative heat exchanger, wherein an inlet connected to the slag outlet of the granulating device is arranged on the top of the high-temperature storage tank, and an outlet connected to the slag particle inlet of the heat exchanger is arranged at the bottom of the high-temperature storage tank; the lower part of one side wall of the high-temperature storage tank is equipped with an air inlet, an air inlet pipeline, and a fan, while the upper part of the opposite side wall is equipped with an air outlet, which is connected to an inlet end of a dust collector through a pipeline, an outlet of the dust collector is connected to the waste heat recovery equipment through a pipeline; preferably, a temperature detection device is installed in the pipeline connected to the dust collector; preferably, an air distribution equipment connected to the air inlet pipeline is arranged at the lower part of the high-temperature storage tank; more preferably, a filter screen, insulation material, and an outer shell are arranged on the side wall of the high-temperature storage tank from the inside out.

The high-temperature storage tank serves as a link between molten slag granulating and slag-particle heat exchanging, facilitating the management of molten slag generated at different power levels without waste, and enabling flexible control of the recuperative heat exchanger.

To prevent the high-temperature solid slag particles in the high-temperature storage tank from agglomerating, it is necessary to cool the slag particles in the high-temperature storage tank. The power of the fan can be controlled through a temperature detection device. The hot air exiting the high-temperature storage tank is sent to the waste heat recovery equipment after being dedusted by the dust collector, then it enters an air purifier through the fan for purification and is discharged after meeting emission standards.

Preferably, the waste heat recovery equipment further comprises a superheater and/or an evaporator, an inlet of the superheater is connected to the saturated steam outlet of the steam drum, and an outlet of the superheater is connected to a steam pipeline network; an inlet of the evaporator is connected to the water tank, and an outlet of the evaporator is connected to the the steam drum water inlet.

The superheater can further heat the saturated steam output from the steam drum, convert the saturated steam into superheated steam (about 220 °C) for use in the steam pipeline network, such as in power plants. At this time, the heat source for converting saturated steam into superheated steam can come from the hot air blown out by the above-mentioned high-temperature storage tank or the air distribution equipment of heat exchanger. At the same time, after heating the saturated steam into superheated steam, the heat source can further preheat the water from the water tank in the evaporator. Afterwards, the preheated water from the evaporator enters the steam drum. Preferably, the hot air first passes through the superheater and then the evaporator in sequence to maximize the use of heat for converting the saturated steam into superheated steam.

Preferably, the superheater and evaporator are arranged in a sealed container, and an air inlet is arranged on the sealed container and connected to an outlet of the dust collector through a pipeline; an outlet of the sealed container is connected to an air purifier through a pipeline and a fan; preferably, the evaporator and the superheater adopt a coil structure; preferably, a water treatment device is further comprised between the evaporator and the water tank.

The water treatment device is used for deoxygenation and desalination treatment of water.

Preferably, the gas-quenching granulating device comprises:
a granulating chamber with a box structure, wherein a molten slag flow inlet is arranged on the top of the granulating chamber, and a molten slag chute is arranged above the molten slag flow inlet; a slag particle flow outlet is arranged at the bottom of the granulating chamber;
a high-pressure nozzle, arranged on the side wall of the granulating chamber, wherein an outlet of the high-pressure nozzle faces the molten slag flow inlet, and an air outlet, a dust collector, and a fan are arranged at the upper part of the other side wall of the granulating chamber; preferably, the high-pressure nozzle is a Laval nozzle.

Performing impacting and granulating by high-pressure air is a type of dry granulation and does not produce wastewater or polluting gases.

Preferably, the gas-water granulating device comprises:
a granulating chamber with a box structure, wherein a molten slag flow inlet is arranged at the top of the granulating chamber, and a molten slag chute is arranged above the molten slag flow inlet; a slag particle flow outlet is arranged at the bottom of the granulating chamber;
a high-pressure nozzle, arranged on the side wall of the granulating chamber, wherein an outlet of the high-pressure nozzle faces the molten slag flow inlet, and a gas-water outlet, a filter, a gas-water separator, and a fan are arranged at the upper part of the other side wall of the granulating chamber, the high-pressure nozzle is an atomizing nozzle or a gas-liquid dual-fluid nozzle.

The ratio of the gas-water mixture can be controlled by a compressed air flow control valve and a water flow control valve.

Preferably, the rotary cup granulating device comprises:
a granulating chamber with a box structure, wherein a molten slag flow inlet is arranged at the top of the granulating chamber and a molten slag particle flow outlet is arranged at the bottom, an air inlet, an air inlet pipeline, and a fan are arranged at the lower part of one side wall of the granulating chamber, and an air outlet, an air outlet pipeline, a dust collector, and a fan are arranged at the upper part of the other side wall of the granulating chamber;
a rotating motor, arranged at the center of the granulating chamber;
a rotary cup, arranged at an output end of the rotating motor.

Preferably, the heat exchanger comprises:
a drum cylinder, wherein the slag particle inlet is arranged on a side wall of the drum cylinder near the cooling medium outlet, and the slag particle outlet is arranged near a cooling medium inlet on a side wall of the drum cylinder; the drum cylinder is installed with a downward inclination towards the cooling medium outlet side, allowing the slag particles to move from the slag particle inlet to the slag particle outlet; preferably, the drum cylinder is composed of an inner cylinder, an outer cylinder, and insulation material between the inner and outer cylinders;
multiple lifting plates arranged at intervals on an inner wall of the drum cylinder along a circumferential direction of the inner wall of the drum cylinder, wherein the lifting plates are L-shaped;
a cylinder drive device, comprising a gear ring, a driving motor, and a support structure arranged outside of the drum cylinder, wherein the cylinder drive device is used to roll the drum cylinder, and
the heat exchange tube set is arranged at the center of the drum cylinder, on the inner wall of the drum cylinder, and on the inner side of the lifting plates.

The main function of the lifting plate is to scatter high-temperature slag particles. The length and installation angle of the lifting plates are determined based on the flow rate of the high-temperature slag particles being processed.

Preferably, the heat exchange tube set comprises an A-type heat exchange tube set and a B-type heat exchange tube set, multiple fins are vertically arranged on the outer wall of the A-type heat exchange tube set in the circumferential direction to form a finned tube, the A-type heat exchange tube set is located in the center of the drum cylinder, and the fins are preferably ring ribs, column ribs, or plate ribs; the B-type heat exchange tube set is arranged on the lifting plates or the inner wall of the drum cylinder.

When the lifting plates scatter high-temperature slag particles, the B-type heat exchange tube cools the high-temperature slag particles residing inside the lifting plates. The outside of A-type heat exchange tube is welded with fins (ring ribs, column ribs, plate ribs, etc.) to enhance heat exchange between the high-temperature slag particles and the tube wall; preferably, adopting the ring rib fins for enhancing heat exchange.

High temperature slag particles are scattered by the lifting plates in the drum cylinder, and simultaneously exchange heat with the lifting plates and the heat exchange tubes on the drum wall. The scattered high-temperature slag particles come into contact with the finned heat exchange tubes in the center of the drum, thereby cooling. The drum cylinder is installed with a tilt, the high-temperature slag particles gradually move towards the drum outlet during the rolling process, while completing heat exchange.

Preferably, the heat exchange tube set is arranged in the drum cylinder by adopting multiple tube passes, and the number of the tube passes is odd; preferably, the flow resistances of each heat exchange tube are consistent to ensure that the cooling medium does not experience flow deviation.

Preferably, the recuperative waste heat recovery system for high-temperature solid slag particles further comprises:
a buffer tank drum, having an inlet and an inlet pipeline on one side of its side wall, and a discharge outlet and a discharge pipeline on the other side; the buffer tank drum is installed with a tilt toward the discharge outlet side, ensuring that the slag particles move from an inlet end to a discharge end inside the cylinder;
first material lifting plates, which are vertically arranged at intervals along an inner wall of buffer tank drum in the circumferential direction and are L-shaped;
a first drive device, comprising a gear ring, a first driving motor, and a corresponding support structure arranged on the outer wall of the buffer tank drum.

Preferably, the heat exchanger comprises:
a drum cylinder, which is horizontally arranged, and ends of the drum cylinder are arranged with a feed device comprising a slag particle inlet and a discharge device comprising a slag particle outlet;
a material-guiding spiral plate, arranged inside the drum cylinder, wherein it has through-holes for the heat exchange tube set to pass through;
a support roller device, arranged at the bottom of the cylinder near a discharge device end of the cylinder, matching an outer ring surface of the drum cylinder; the support roller device is arranged at the bottom of the cylinder, matching the outer ring surface of the drum cylinder, and is used to support the drum cylinder;
a retaining roller device, arranged at the bottom of the cylinder near a feed device end of the cylinder, matching a side surface of the drum cylinder; the retaining roller device is used to stabilize the tilt-installed drum cylinder, ensuring stable rolling;
a transmission device, arranged at the support roller device; the drum cylinder is supported by the support roller device and the retaining roller device and can perform continuous rotary motion driven by the transmission device; wherein
the heat exchange tube set is uniformly arranged inside the drum cylinder.

It takes about 40 minutes for slag particles moving from the inlet end to the discharge end of the heat exchanger, and the temperature drops from 750 °C to 200 °C or less.

Preferably, the recuperative waste heat recovery system for high-temperature solid slag particles satisfies one or more of the following:
the cylinder is composed of three sections, which are respectively made of heat-resistant stainless steel, stainless steel, and alloy steel, forming a high temperature section, a medium temperature section, and a low temperature section in sequence;
the transmission device is composed of a main transmission system and an auxiliary transmission system that are mutually self-locking, wherein a main motor of the main transmission system adopts a variable-frequency speed-regulating motor;
a length of the material-guiding spiral plate extending beyond the cylinder is 100-200 mm.

The cylinder of drum cylinder is composed of three sections, which are respectively made of heat-resistant stainless steel, stainless steel, and alloy steel, and the cylinder is divided into a high temperature section (750 °C-550 °C), a medium temperature section (550 °C-350 °C), and a low temperature section (less than 350 °C); adapting to the temperature change demand of sections of the heat exchanger, reducing from 750 °C to 200 °C or less, and the production cost can be reduced by using different materials.

The transmission device is composed of a main transmission system and an auxiliary transmission system that are mutually self-locking (when the main transmission system is activated, the auxiliary transmission system cannot be activated, and vice versa), wherein a main motor of the main transmission system adopts a variable-frequency speed-regulating motor, which can adjust the rotation speed of the drum cylinder to meet the operation needs of the heat exchanger. When the drum cylinder is under maintenance or the main motor is powered off, starting the auxiliary transmission system.

Preferably, the heat exchanger comprises:
a heat exchanger cylinder, equipped with a feed box comprising a slag particle inlet and a discharge box comprising a slag particle outlet at the ends of the heat exchanger cylinder, the ends of the heat exchanger cylinder near the discharge box and the feed box are respectively arranged with a water header and a steam-water header;
twin support-retaining roller devices, arranged on both sides of the heat exchanger cylinder;
a rotary drive device, arranged at the bottom of the middle part of the cylinder of the heat exchanger cylinder; wherein,
the steam drum and the heat exchanger form a closed circulatory system;
the waste heat recovery equipment comprises a superheater, which is sequentially equipped with a preheating module, a superheating module, and a combustion module from top to bottom; the steam drum is connected to the preheating module through a water inlet pipe and connected to the superheating module through a steam outlet pipe;
a blowdown pipe and an emergency water discharge pipe are arranged at the bottom of the steam drum, and the blowdown pipe and the emergency water discharge pipe are connected to a blowdown expansion vessel;
a regulating valve, preferably an electric regulating valve, is arranged on an inlet pipeline of the water tank, and an outlet pipeline of the water tank is connected to an inlet of water supply pump, an outlet pipeline of the water supply pump is connected to an inlet of the superheater; preferably, the water tank is equipped with a liquid level gauge.

Preferably, the heat exchanger satisfies one or more of the following:
continuous spiral support tube sheets are welded on the inner wall of the heat exchanger cylinder, the continuous spiral support tube sheets are spirally distributed along an axis direction inside the heat exchanger cylinder; corresponding through-holes are arranged on the spiral support tube sheets, and the heat exchange tube set is inserted into the through-holes of the spiral support tube sheets; both ends of the heat exchanger cylinder are equipped with flange tube sheets, and the ends of the heat exchange tube are respectively fixed to two flange tube sheets, which are fixedly connected to the steam-water header and the water header, respectively. One end of the heat exchange tube is connected to the water header, and the other end of the heat exchange tube is connected to the steam-water header. The water header is rotatably connected to a water inlet rotary joint, and the steam-water header is rotatably connected to a steam outlet rotary joint, with graphite material used for sealing at the rotary connection. The steam-water header and the water header rotate together with the heat exchanger cylinder.

The heat exchanger cylinder is equipped with an inner cylinder wall and an outer cylinder wall, the inner cylinder wall and the heat exchange tube form a heat exchange space, and insulation material is filled between the inner cylinder wall and the outer cylinder wall. End plates are arranged at the inner and outer cylinder walls and the ends, and discharge scrapers are circumferentially welded between the end plates and the flange tube sheet on the discharge side.

Preferably, the superheater is sequentially equipped with a preheating module, a superheating module, and a combustion module from top to bottom;
the combustion module comprises a furnace, a burner, a flue-gas circulating pipeline, and a circulating fan;
the superheating module comprises a steam inlet, a steam inlet header, a steam outlet header, a steam outlet, and a superheating tube set;
a steam outlet pipeline of the steam drum is connected to the steam inlet of the superheating module, and the saturated steam in the steam drum is transported into the steam inlet header through the steam inlet of the superheating module, and the saturated steam is uniformly distributed to the superheating tube set by the steam inlet header;
the preheating module comprises a water inlet, a water inlet header, a water outlet header, a water outlet, and a preheating tube set; the outlet pipeline of the water supply pump is connected to the water inlet, and cold water from the water tank is transported into the water inlet header through the water inlet, and cold water is uniformly distributed to the preheating tube set by the water inlet header; the flue gas after heat exchange in the superheating module flows upward through the preheating module, heating the cold water in the preheating tube set, after being collected by the water outlet header on the preheating module, a water outlet on the water outlet header is connected to a water inlet pipe of the steam drum, and hot water is transported into the steam drum.

The present invention provides a recuperative waste heat recovery method for high-temperature solid slag particles, comprises the following steps:
a) introducing molten slag into a granulating device for molten slag granulating treatment to obtain slag particles, and air during the molten slag granulating process performs a contact heat exchange with the molten slag and is discharged through a dust collector and a fan; preferably, the molten slag granulating treatment adopts gas-quenching granulating, gas-water granulating, or rotary cup granulating;
b) introducing the slag particles into the recuperative heat exchanger, where the slag particles perform an indirectly contact heat exchange with water or steam from a steam drum through a heat exchange tube set, and the water or steam absorbs heat and then returns to the steam drum and/or a superheater and an evaporator;
c) sending the heat-exchanged slag particles out through a conveyor.

Preferably, in step b), slag particles uniformly fall under the action of guide plates of the recuperative heat exchanger, and during the falling process, they exchange heat with air blown out by an air distribution equipment arranged at the lower part of the recuperative heat exchanger.

Preferably, in step b), the slag particles perform an indirectly contact heat exchange with water or steam from the steam drum through the heat exchange tube set, and/or a cylinder heat exchange tube sleeve, and/or a core-shaft heat exchange tube, the heat-exchanged slag particles are pushed down to the conveyor by a spiral plate and are discharged through the conveyor.

Preferably, in step b), saturated water from the steam drum enters a second heat exchange tube in a vaporization section of the recuperative heat exchanger, after heat exchange with the high-temperature slag particles, it becomes a saturated water-steam mixture, in which is then returned to the steam drum through a pipeline to achieve steam water separation; the saturated steam in the steam drum flows into a first heat exchange tube of a superheating section of the recuperative heat exchanger under pressure difference, and after heat exchange with the slag particles, it forms superheated steam, which is then connected to a steam pipe network through a buffer tank via a pipeline; preferably, when the slag flow rate is lower than a set value, the steam pipeline in the superheating section is closed.

Preferably, before step b), the slag particles first enter a high-temperature storage tank for temporary storage, and then enter the recuperative heat exchanger; during the temporary storage of the slag particles in the high-temperature storage tank, hot air generated in the high-temperature storage tank is sent to a waste heat recovery equipment for heat exchange after being dusted by a dust collector; preferably, multiple high-temperature storage tanks are adopted and arranged in parallel.

The advantages of the present invention are:
1. The present invention enables large-scale high-temperature slag particles waste heat recovery, and the heat recovery medium used is mainly water. During water vaporization, a large amount of latent heat is absorbed, and the convection heat exchange and boiling heat exchange coefficients between water and metal tube walls are very high (heat flux density is on the order of 10⁵ W/m²), improving the efficiency of waste heat recovery.
2. The present invention avoids heat loss of the intermediate heat transfer medium through direct heat exchange between high-temperature slag particles, the heat exchange tube set, and the cooling medium (water). The flow and heat exchange of high-temperature slag particles outside the heat exchange tube transfer heat to the water or steam inside the heat exchange tube, ultimately generating superheated steam. Meanwhile, cold water or saturated water can further utilize the remaining waste heat, thereby achieving maximum recovery of high-temperature slag particle waste heat.

### BRIEF DESCRIPTION OF THE DRAWINGS

FIG. 1 is a schematic diagram of the slag particle waste heat recovery system according to an example of the present invention.

FIG. 2 is a schematic diagram of the slag particle waste heat recovery system according to another example of the present invention.

FIG. 3 is a schematic diagram of the slag particle waste heat recovery system according to another example of the present invention.

FIG. 4 is a schematic diagram of an internal structure of the heat exchanger according to an example of the present invention.

FIG. 5 is a schematic diagram of the slag particle waste heat recovery system according to a modified embodiment of the present invention.

FIG. 6 is a schematic diagram of the slag particle waste heat recovery system according to another modified embodiment of the present invention.

FIG. 7 is a schematic diagram of the high-temperature storage tank according to the present invention.

FIG. 8 is a schematic diagram of the structure and process of another granulating device according to the present invention.

FIG. 9 is a schematic diagram of the structure and process of another granulating device according to the present invention.

FIG. 10 is a schematic diagram of the heat exchanger according to the present invention.

FIG. 11 is a cross-sectional schematic diagram of the heat exchanger according to the present invention.

FIG. 12 is a schematic diagram of the buffer tank drum according to the present invention.

FIG. 13 is a cross-sectional schematic diagram of the buffer tank drum according to the present invention.

FIG. 14 is a schematic diagram of another heat exchanger according to the present invention.

FIG. 15 is an enlarged cross-sectional view along line A-A of FIG. 14.

FIG. 16 is a cross-sectional view of the drum cylinder of another heat exchanger according to the present invention.

FIG. 17 is a side view of FIG. 16.

FIG. 18 is a cross-sectional view of the feed device of another heat exchanger according to the present invention.

FIG. 19 is an enlarged cross-sectional view along line B-B of FIG. 1.

FIG. 20 is a cross-sectional view of the discharge device of another heat exchanger according to the present invention.

FIG. 21 is an enlarged cross-sectional view along line C-C of FIG. 1.

FIG. 22 is a three-dimensional view of the material-guiding spiral plate of another heat exchanger according to the present invention.

FIG. 23 is a schematic diagram of the slag particle waste heat recovery system according to another example of the present invention.

FIG. 24 is a schematic diagram of the heat exchanger according to another example of the present invention.

FIG. 25 is a schematic diagram of the heat exchanger cylinder according to another example of the present invention.

FIG. 26 is a schematic diagram the superheater according to another example of the present invention.

### DETAILED DESCRIPTION

Referring to the embodiment of the invention in detail now, one or more examples are shown in the accompanying drawings. The detailed description uses the numerical and alphabetical references to denote features in the drawings. Similar or identical reference numerals in the drawings and description have been used to refer to similar or identical parts of the invention.

The limitations of each feature can be combined and interchanged here and throughout the specification and claims, unless otherwise stated in the context. For example, all ranges disclosed herein include components and devices, provided that their functions are similar, indicating their interchangeability.

### Example 1

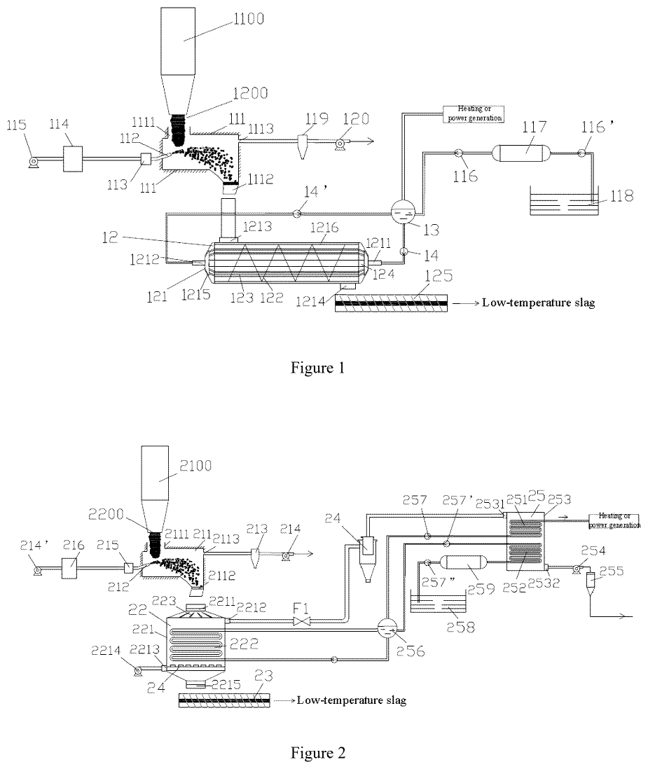

Referring to FIG. 1, it shows a recuperative waste heat recovery system for high-temperature solid slag particles, comprising:
a granulating device 11, which is a gas-quenching granulating device, comprising,
a granulating chamber 111, having a box-structure, with a slag flow inlet 1111 at the top, and a slag chute 1100 arranged above the slag flow inlet 1111; a high-temperature slag outlet 1112 is arranged at the bottom of the granulating chamber 111;
a high-pressure nozzle 112, which is a supersonic nozzle arranged at the upper part of one side wall of the granulating chamber 111. The outlet of the high-pressure nozzle 112 corresponds to the high-temperature molten slag 1200 entering from the slag flow inlet 1111; preferably, the high-pressure nozzle 112 is connected to an air compressor 113, an air processor 114, and a fan 115; the upper part of the other side wall of the granulating chamber 111 is equipped with an air outlet 1113, a dust collector 119, and a fan 120; more preferably, the high-pressure nozzle 112 is a Laval nozzle; the dust collector 119 is a cyclone dust collector or a bag dust collector;
a recuperative heat exchanger 12, comprising a cylinder 121, which is of a metal shell-and-tube structure and is equipped with a cooling medium inlet 1211 and a cooling medium outlet 1212 at ends. The cooling medium inlet 1211 and the cooling medium outlet 1212 are respectively connected to the waste heat recovery equipment; preferably, a cooling medium distribution device 1215 is installed the cooling medium outlet 1212 side; an inlet 1213 is arranged on the side wall of the cylinder near the cooling medium outlet 1212 and connected to the high-temperature slag outlet 1112 of the granulating device 11 through a conveying pipeline; a low-temperature slag outlet 1214 is arranged on the side wall of the cylinder 121 on the cooling medium inlet 1211 side of the recuperative heat exchanger 12; a spiral plate 122 is arranged in the recuperative heat exchanger 12, and has several interconnected through-holes on it. Heat exchange tube set 123 are inserted into the through holes; preferably, the outer surface of the outlet side of the cylinder is circumferentially welded with a scraper;
a conveyor 125, arranged below the low-temperature slag outlet 1214 of the recuperative heat exchanger 12, and preferably, the conveyor 125 is a spiral conveyor.

The waste heat recovery equipment comprises:
a steam drum 13, connected to the cooling medium inlet 1211 of the recuperative heat exchanger 12 through a downcomer and a circulating pump 14; the cooling medium outlet 1212 of the recuperative heat exchanger 12 is connected to the steam-water mixture inlet of the steam drum 13 through a pipeline, and the saturated steam pipe of the steam drum 13 is connected to a steam pipe network; a water supply pipeline of the steam drum 13 is connected to a water tank 118 through a water pump 116, a water treatment device 117, and a water pump 116′.

Preferably, a shell of the cylinder 121 of the recuperative heat exchanger 12 adopts a water-cooled wall structure, comprising a cylinder heat exchange tube sleeve 1216, a core-shaft heat exchange tube 124, a spiral plate 122 arranged inside the cylinder 121, and a heat exchange tube set 123 inserted into the spiral plate 122.

The slag particles waste heat recovery method of Example 1 is as follows:
1) molten slag enters the granulating device for molten slag granulating treatment to obtain slag particles, air during the molten slag granulating process performs a contact heat exchange with molten slag and is discharged through the dust collector and the fan;
2) the slag particles enter the recuperative heat exchanger, where they perform an indirectly contact heat exchange with water or steam from steam drum through the heat exchange tube set, and the water or steam absorbs heat and then returns to the steam drum and/or superheater and evaporator for heat exchange; the heat-exchanged low-temperature slag particles are pushed down to the conveyor by the spiral plate 22 and discharged through the conveyor.

### Example 2

Referring to FIG. 2, it shows a variation form of a recuperative waste heat recovery system for high-temperature solid slag particles, comprising:
a granulating device 21, which is a gas-quenching granulating device, comprising:
a granulating chamber 211, having a box-structure, with a slag flow inlet 2111 at the top and a slag chute 2100 above the slag flow inlet 2111; a high-temperature slag discharge outlet 2112 is arranged at the bottom of granulating chamber 211;
a high-pressure nozzle 212, which is a supersonic nozzle arranged at the upper part of one side wall of the granulating chamber 211; the outlet of the high-pressure nozzle 212 corresponds to the high-temperature slag 2200 entering from the slag flow inlet; an air outlet 2113, a dust collector 213, and a fan 214 are arranged on the upper part of the other side wall of the granulating chamber 211; preferably, the high-pressure nozzle 212 is connected to an air compressor 215, an air processor 216, and a fan 214′; more preferably, the high-pressure nozzle 212 is a Laval nozzle.
a recuperative heat exchanger 22, comprising a cylinder 221, with a slag particle inlet 2211 and a valve at the top, corresponding to the high-temperature slag discharge outlet 2112 of the granulating device 1; the upper part of one side wall of the cylinder 221 is equipped with an air outlet 2212, and the lower part of the other side wall is equipped with an air inlet pipeline 2213 and a fan 2214; the bottom of cylinder 221 is equipped with a slag particle outlet 2215 and a valve; heat exchange tubes 222 are arranged inside the cylinder 221, and the both ends (namely the inlet and outlet) of the heat exchange tubes 222 are located outside the cylinder 221 and connected to the waste heat recovery equipment 25 through pipelines; preferably, a guide plate 223 that guides slag particles uniform flowing and falling is arranged at the upper part inside the cylinder 221 below the slag inlet 2211; more preferably, the lower part inside the cylinder 221 is equipped with an air distribution equipment 224, and the preferred air distribution equipment 224 is an air distribution plate;
a conveyor 23, arranged below the slag particle outlet 2215 of the cylinder 221; preferably, the conveyor 23 is a spiral conveyor or a belt conveyor;
a dust collector 24, an inlet end of the dust collector is connected to the air outlet 2212 of the cylinder 221 of the recuperative heat exchanger 22 through a pipeline and a valve F1; the outlet of dust collector 24 is connected to the waste heat recovery equipment 25 through a pipeline.

Preferably, the waste heat recovery equipment 25 comprises:
a superheater 251 and an evaporator 252, arranged in a sealed container 253, with an air inlet 2531 arranged on the sealed container 253 and connected to the outlet of the dust collector 24 through a pipeline; the outlet 2532 of the sealed container 25 is connected to an air purifier 255 through a pipeline and a fan 254; preferably, the evaporator 252 and superheater 251 adopt a coil-tube structure;
a steam drum 256, an inlet of the steam drum is connected to the water outlet of heat exchange tube 222 through a pipeline; the saturated steam outlet of the steam drum 256 is connected to the inlet of the superheater 251 through a pipeline and a valve 257, and the outlet pipeline of the superheater 251 is connected to a steam pipe network; the water inlet of the steam drum 256 is connected to the outlet of the evaporator 252 through a pipeline and a water pump 257′, and the inlet of the evaporator 252 is connected to a water tank 258 through a pipeline and a water pump 257″; preferably, a water treatment device 259 is arranged in the inlet pipeline of the evaporator 252.

The slag particles waste heat recovery method of Example 2 is as follows:
1) molten slag enters the granulating device for molten slag granulating treatment to obtain slag particles, air during the molten slag granulating process performs a contact heat exchange with molten slag and is discharged through a dust collector and a fan;
2) the slag particles enter the recuperative heat exchanger, where the slag particles perform an indirectly contact heat exchange with water or steam from the steam drum through the heat exchange tube set, and the water or steam absorbs heat and then returns to the steam drum and/or superheater and evaporator for heart exchange; the slag particles uniformly fall under the action of the guide plate of the recuperative heat exchanger, and during the falling process, they exchange heat with air blown out by the air distribution equipment arranged at the lower part of the recuperative heat exchanger, while slowing down the falling time;
3) supplying water in the recuperative heat exchanger is provided by the steam drum, and the supplying water absorbs heat then returns to the steam drum; the heat from the hot air from the recuperative heat exchanger is transferred to the superheater, and ultimately the water is converted into superheated steam through the superheater for external output.

### Example 3

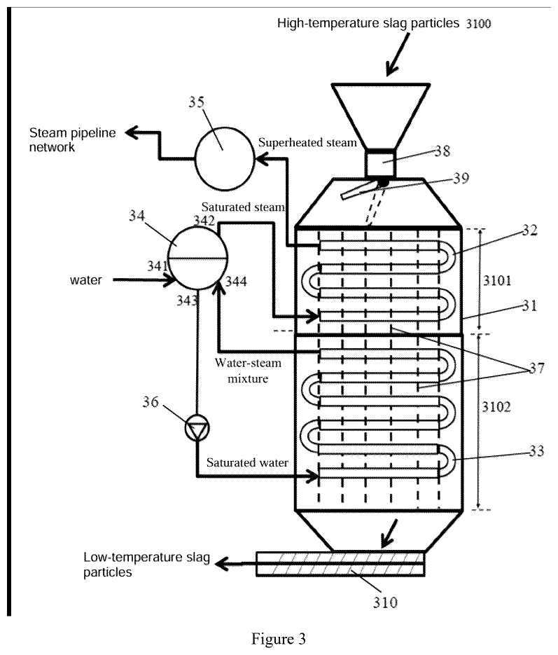

Referring to FIG. 3, it shows another variation form of the recuperative waste heat recovery system for high-temperature solid slag particles, comprising:
a heat exchanger 31, with a metal shell-and-tube structure, divided into a superheating section 3101 and a vaporization section 3102 from top to bottom; a first heat exchange tube 32 and a second heat exchange tube 33 are respectively arranged in the superheating section 3101 and the vaporization section 3102;
a steam drum 34, an inlet 341, a saturated steam outlet 342, a saturated water outlet 343, and a saturated steam-water mixture inlet 344 are arranged on the steam drum; the saturated steam outlet 342 is connected to an inlet end of the first heat exchange tube 32 in the superheating section 3101 of the heat exchanger 31 through a pipeline, and an outlet end of the first heat exchange tube 32 is connected to a steam pipe network through a buffer tank 35 through a pipeline; the saturated water outlet 343 is connected to an inlet end of the second heat exchange tube 33 in the vaporization section 3102 of the heat exchanger 31 through a pipeline and a circulating pump 36; an outlet end of the second heat exchange tube 33 is connected to the saturated steam-water mixture inlet 344 of the steam drum 34 through a pipeline;
guide plates 37, vertically arranged at intervals inside the heat exchanger 31, with through holes for the first and second heat exchange tubes 32, 33 to pass through;
a material loading-distributing device 38, arranged at the top of the heat exchanger 31;
a material distributing chute 39, arranged inside the heat exchanger 31 and below the material loading-distributing device 38; high temperature slag particles 3100 enter the heat exchanger 31 through the material loading-distributing device 38 via the material distributing chute 39; and
a discharge device 310, arranged at the discharge outlet at the bottom of the heat exchanger 31.

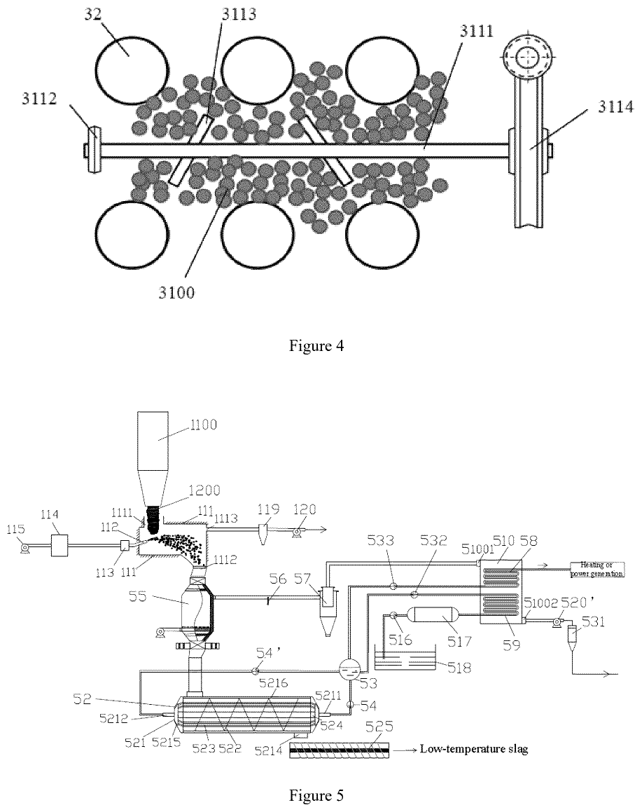

Further referring to FIG. 4, the recuperative waste heat recovery system for high-temperature solid slag particles also comprises:
a disturbance rod 3111, inserted between the first heat exchange tube 32 and the second heat exchange tube 33 in the heat exchanger 31, one end of the disturbance rod is fixed to a fixed base 3112 and the other end of the disturbance rod extends out the heat exchanger 31; several disturbance arms 3113 are arranged at intervals along the axial direction on rod body of the disturbance rod 3111, and an axis of the disturbance arm 3113 and an axis of the disturbance rod 3111 form an angle; preferably, adjacent disturbance arms 3113 are installed in an anti-symmetric manner;
a drive device 3114, wherein an output end of the drive device is connected to the end of the disturbance rod 3111 extending out the heat exchanger 31.

Preferably, the drive device 3114 is of a worm and worm wheel type, wherein the worm wheel is coaxially connected to the end of the disturbance rod 3111.

The slag particles waste heat recovery method of Example 3 is as follows:
1) high temperature slag particles are uniformly distributed at the inner top of the heat exchanger by the material loading-distributing device and the material distributing chute, forming a horizontal material surface, and flow downward under gravity;
2) saturated water flows out from the steam drum under the drive of the circulating pump and enters the second heat exchange tube of the vaporization section of the heat exchanger; after heat exchange with high-temperature slag particles, it becomes a saturated steam-water mixture, which is then returned to the steam drum through a pipeline, achieving steam water separation;
3) the saturated steam in the steam drum flows into the first heat exchange tube of the superheating section of the heat exchanger under pressure difference; after heat exchange with high-temperature slag particles, it forms superheated steam, which then flows into the buffer tank through a pipeline and finally enters the steam pipe network;
4) the high-temperature slag particles are converted into low-temperature slag particles through heat exchange with the first and second heat exchange tubes, move to the discharge outlet at the bottom of the heat exchanger, and are discharged out from the heat exchanger through the discharge device.

Preferably, when the slag flow rate is low, closing the steam pipeline in the superheating section and switching to saturated steam production, ensuring that the pipeline outlet of the vaporization section is a water-steam mixture.

Example 3 is mainly divided into three cycles:
1. The heat exchange tube is arranged in the vaporization and superheating sections of the heat exchanger. Saturated water flows out from the steam drum and enters the vaporization section under the drive of the circulating pump. After heat exchange with high-temperature slag particles, the saturated water turns into a mixture of saturated water and steam, then flows into the steam drum, achieving steam water separation.
2. The saturated steam in the steam drum flows into the superheating section of the heat exchanger under pressure difference, exchanges heat with high-temperature slag particles, forms the superheated steam, flows into the buffer tank, and finally enters the steam pipe network.
3. The high-temperature slag particles are transported to the material loading-distributing device and uniformly distributed at the top of the heat exchanger through the material distributing chute, forming a horizontal material surface. the high temperature slag particles flow downward inside the heat exchanger under gravity, and the heat exchange tubes and guide plates act as constraints on the flow of slag particles, avoiding the macro-scale flow deviation of slag particles. When the slag particles reach the bottom of the heat exchanger, slag particles are discharged from the heat exchanger through the discharge device. The low-temperature slag particles enter the next processing stage.

During operation, the device should ensure that the pipeline outlet of the vaporization section of the heat exchanger is a water-steam mixture; the device perform material distributing to ensure that the material surface is flat and there is no height difference between the guide plates; the discharge device should be able to control the flow rate of the slag.

### Example 4

Referring to FIGS. 5 and 7, Example 4 based on Example 1, further comprises: at least one high-temperature storage tank 55, arranged between the granulating device 111 and a recuperative heat exchanger 52; an inlet 551 connected to the high-temperature slag outlet 1112 of the granulating device 111 and an inlet gate are arranged at the top of the high-temperature storage tank 55; an outlet 552 connected to an inlet 5213 of a cylinder 521 of the recuperative heat exchanger 52 and an outlet gate are arranged at the bottom of the high-temperature storage tank 55; an air inlet 553, an air inlet pipeline, and a fan 554 are arranged on the lower part of one side wall of the high-temperature storage tank 55; an air outlet 555 is arranged on the upper part of the opposite side wall and connected to a dust collector 57 through a pipeline and a valve; preferably, a temperature detection device 56 is arranged in the pipeline; preferably, an air distribution equipment 556 connected to the air inlet pipeline is arranged at the lower part inside the high-temperature storage tank 55. In the example, the air distribution equipment 556 is an air distribution plate; more preferably, a filter screen 5501, insulation material 5502, and an outer shell 5503 are arranged on the side wall of the high-temperature storage tank 55 from the inside out.

The waste heat recovery equipment comprises:
a steam drum 53, connected to the cooling medium inlet 5211 of the recuperative heat exchanger 52 through a downcomer and a circulating pump 54; the cooling medium outlet 5212 of the recuperative heat exchanger 52 is connected to a steam-water mixture inlet of the steam drum 53 through a pipeline and a circulating pump 54′;
a superheater 58 and an evaporator 59, arranged in a sealed container 510, an inlet 51001 and an outlet 51002 are arranged on the sealed container 510; the inlet is connected to the outlet pipeline of the dust collector 57 through a pipeline; the outlet of sealed container 510 is connected to a fan 520′ and an air purifier 531 through a pipeline; the saturated steam pipe of the steam drum 53 is connected to an inlet of the superheater 58 through a saturated steam valve 533, and the outlet of the superheater 58 is connected to the steam pipe network; an inlet pipeline of the evaporator 59 is connected to a water treatment device 517, a water pump 516, and a water tank 518; a water pump 532 is arranged on the outlet pipeline of the evaporator 59 and connected to a water supply pipeline of the steam drum 53.

The slag particles first enter the high-temperature storage tank for temporary storage and then enter the recuperative heat exchanger. During the temporary storage of the slag particles in the high-temperature storage tank, the hot air generated in the high-temperature storage tank is sent to the waste heat recovery equipment for heat exchange after being dedusted by the dust collector. Preferably, multiple high-temperature storage tanks are adopted and arranged in parallel.

### Example 5

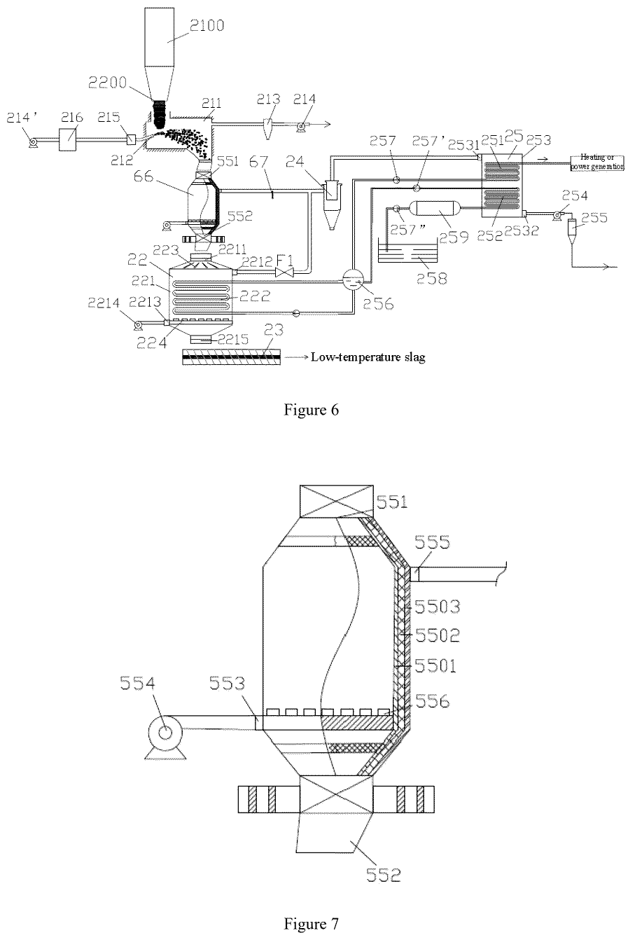

Referring to FIGS. 6 and 7, Example 5 based on Example 2, further comprises:
at least one high-temperature storage tank 66, arranged between the granulating device 211 and the recuperative heat exchanger 22.

An inlet 551 connected to the discharge outlet at the bottom of the granulating tank 211 and an inlet gate are arranged at the top of the high-temperature storage tank 66; an outlet 552 connected to the slag particle inlet 2211 of the cylinder 221 of the recuperative heat exchanger 22 and an outlet gate are arranged at the bottom of the high-temperature storage tank 66; an air inlet 553, an air inlet pipeline, and a fan 554 are arranged at the lower part of one side wall of the high-temperature storage tank 66; an air outlet 555 is arranged at the upper part of the opposite another side wall and connected to the inlet pipeline of the dust collector 24 through a pipeline; preferably, a temperature detection device 67 is arranged in the pipeline; an air distribution equipment 556 is arranged at the lower part of the high-temperature storage tank 66 and connected to the air inlet pipeline; the air distribution equipment 556 is preferably an air distribution plate and is connected to the fan; more preferably, a filter screen 5501, insulation material 5502, and an outer shell 5503 are arranged on the side wall of the high-temperature storage tank 66 from the inside out.

The slag particles first enter the high-temperature storage tank for temporary storage and then enter the recuperative heat exchanger. During the temporary storage of the slag particles in the high-temperature storage tank, the hot air generated in the high-temperature storage tank is sent to the waste heat recovery equipment for heat exchange after being dedusted by a dust collector; preferably, multiple high-temperature storage tanks are adopted and arranged in parallel.

### Example 6

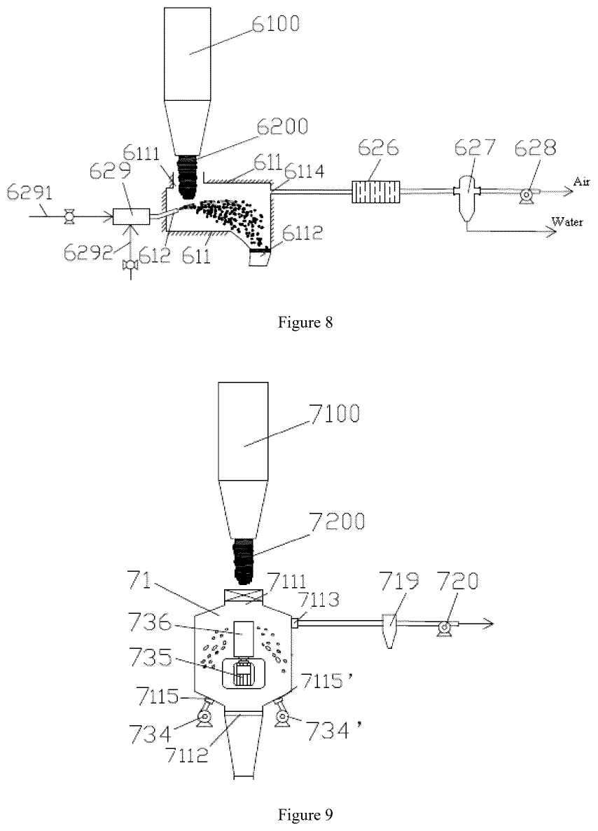

Referring to FIG. 8, it shows a gas-water granulating device as another embodiment of the granulating device, which can replace the gas quenching granulating device in the previous examples. The gas-water granulating device comprises:
a granulating tank 611 with the box-structure, a slag flow inlet 6111 is arranged at the top of granulating tank, and a slag chute 6100 is arranged above the slag flow inlet 6111; a slag flow outlet 6112 is arranged at the bottom of the granulating tank 611;
a high pressure nozzle 612, which is an atomizing nozzle or a gas-liquid dual fluid nozzle, arranged on the upper side wall of the granulating tank 611; an outlet of the high-pressure nozzle 612 corresponds to a high-temperature molten slag 6200 entering through the slag flow inlet 6111; the high-pressure nozzle 612 is connected to a gas-water mixer 629, and the gas-water mixer 629 is respectively connected to a compressed air pipeline and an air flow control valve 6291, and a water supply pipeline with a water flow control valve 6292; an air-water outlet 6114, a filter 626, a gas-water separator 627, and a fan 628 are arranged on the upper part of the other side wall of the granulating tank 611.

### Example 7

Referring to FIG. 9, it shows a rotary cup granulating device as another embodiment of the granulating device, which can replace the gas quenching granulating device in the previous examples. The rotary cup granulating device comprises:
a granulating chamber 711 with the box structure, a slag flow inlet 7111 is arranged at the top of granulating chamber, and a slag flow outlet 7112 is arranged at the bottom of granulating chamber; air inlets 7115, 7115′, air inlet pipelines, and fans 734, 734′ are arranged on the lower part of the side wall of granulating chamber 711, with an air outlet 7113, an air outlet pipeline, a dust collector 719, and a fan 720 are arranged on the upper part of the other side wall of granulating chamber 711,
a rotating motor 735, arranged vertically at the center of the granulating chamber 711;
a rotary cup 736, arranged at an output end of the rotating motor 735.

### Example 8

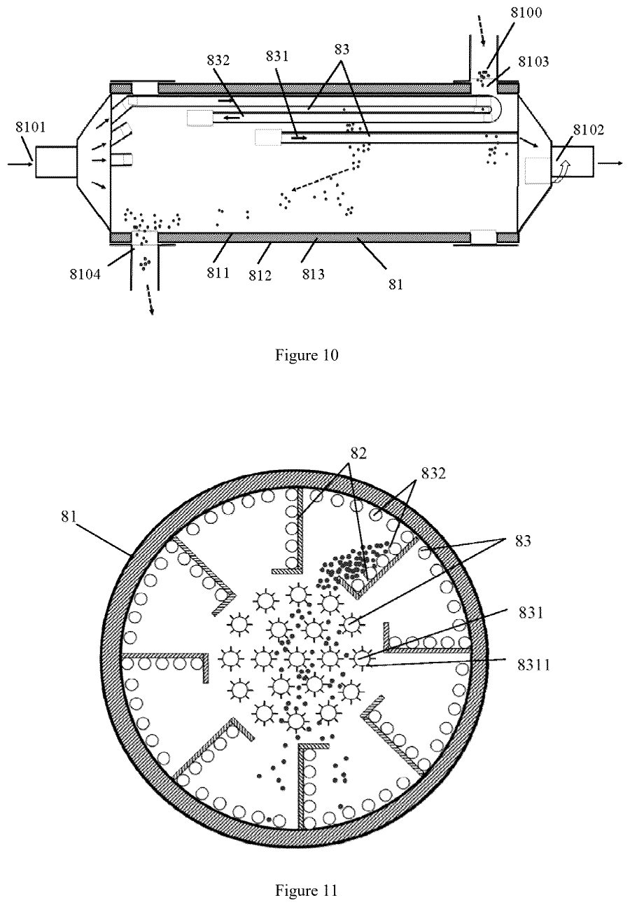

Referring to FIGS. 10 and 11, it further shows the structure of the recuperative heat exchanger 22 in Example 2, comprising:
a drum cylinder 81, an cooling medium inlet 8101 and an cooling medium outlet 8102 are arranged at both ends of the drum cylinder and respectively connected to external pipelines through rotary joints; a high-temperature slag particle inlet and an inlet pipeline 8103 are arranged on the side wall of the drum cylinder 81 near the cooling medium outlet 8102, and a low-temperature slag particle outlet and an outlet pipeline 8104 are arranged on the side wall of the drum cylinder 81 near the cooling medium inlet 8101; the drum cylinder 81 is installed with a downward tilt toward the outlet side of the cooling medium, ensuring that high-temperature slag particles move from an inlet end to a discharge end inside the drum cylinder 81;
several lifting plates 82, the lifting plates 82 are L-shaped, with one end vertically arranged at intervals along the inner wall of the drum cylinder 81 along the circumferential direction;
heat exchange tubes 83, arranged respectively at the center of the drum cylinder 81, the inner wall of the drum cylinder 81, and the inner side of the lifting plate 82;
a drive device (not shown in the figure), comprising a gear ring, a driving motor, and corresponding support structures arranged on the outside of the drum cylinder 81.

Preferably, the drum cylinder 81 is composed of an inner cylinder 811, an outer cylinder 812, and insulation material 813 between the inner cylinder 811 and the outer cylinder 812.

Preferably, the heat exchange tubes 83 comprise an A-type heat exchange tube set 831 and a B-type heat exchange tube set 832; the outer wall of the A-type heat exchange tube set 831 is vertically equipped with fins 8311 along the circumferential direction, forming finned tubes; the A-type heat exchange tube set 831 is arranged at the center of the drum cylinder 81, and preferably, the fins 8311 are ring ribs, column ribs, or plate ribs; the B-type heat exchange tube set 832 is arranged on the lifting plates 82 or the inner wall of the drum cylinder 81.

Preferably, the heat exchange tubes 83 are arranged in the drum cylinder using multiple tube passes, and the number of tube passes is odd; preferably, the resistance of the tube passes of each heat exchange tube is consistent.

### Example 9

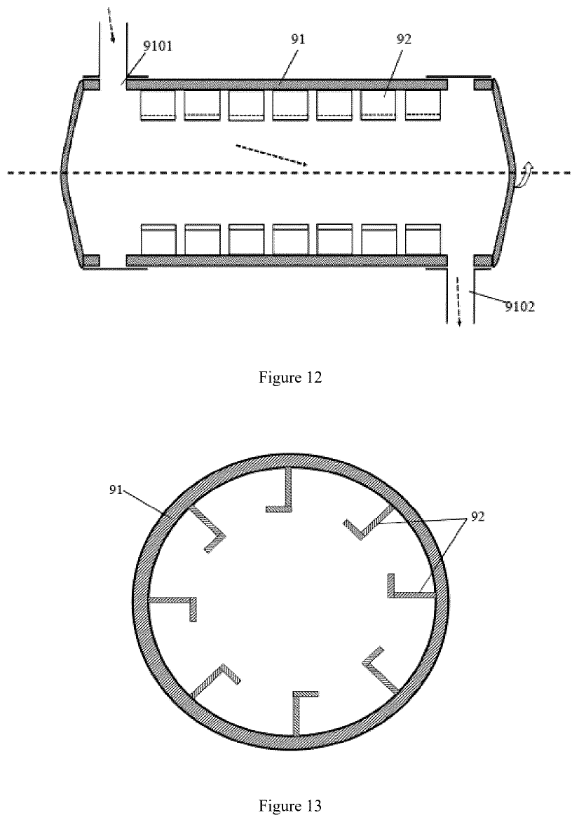

Referring to FIGS. 12 and 13, based on Example 8, a buffer tank drum 91 can be further connected in series before the high-temperature slag particle inlet of the recuperative heat exchanger 22, comprises:
a buffer tank drum 91, an inlet and an inlet pipeline 9101 are arranged on one side wall of the buffer tank drum, and a discharge outlet and a discharge outlet pipeline 9102 are arranged on the other side wall of the buffer tank drum; the buffer tank drum 91 is installed with a tilt toward the discharge outlet side, ensuring that the high-temperature slag particles move from an inlet end to a discharge end inside the cylinder;
first lifting plates 92, they are L-shaped, with one end vertically arranged at intervals along the inner wall of the buffer tank drum 91 along the circumferential direction;
a first drive device (not shown in the figure), comprising a gear ring, a first driving motor, and corresponding support structures arranged on the outer wall of the buffer tank drum.

### Example 10

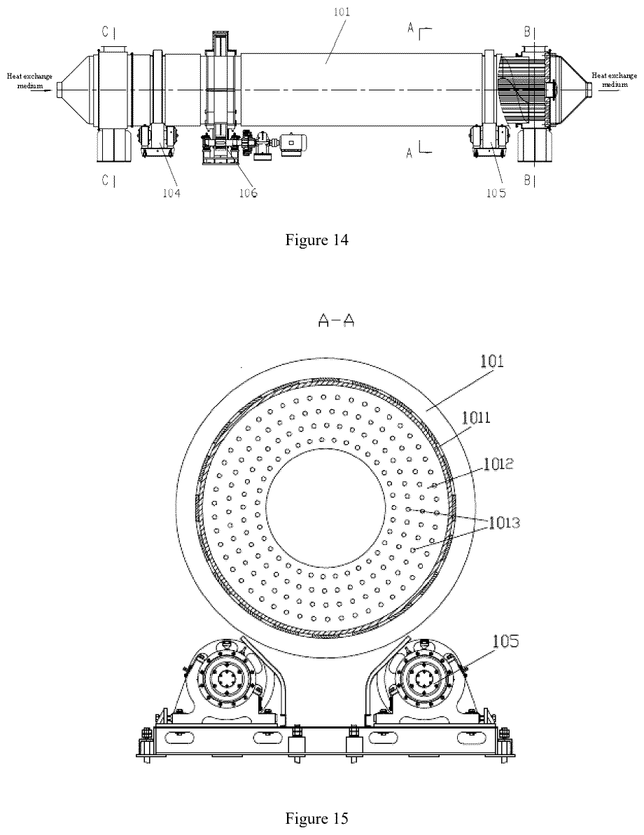

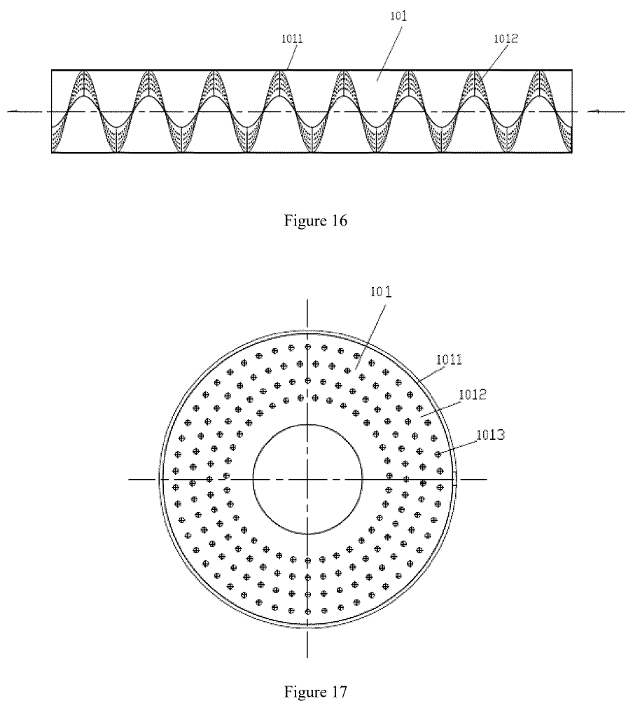

Referring to FIGS. 14 to 22, another structure of the recuperative heat exchanger 22 in Example 2 is further illustrated, comprising:
a drum cylinder 101, which is horizontally arranged and mainly consists of a cylinder 1011, a material-guiding spiral plate 1012, and a heat exchange tube set 1013; the material-guiding spiral plate 1012 is welded to the inner wall of the cylinder 1011, and there are several through-holes 10121 arranged on the material-guiding spiral plate 1012; the heat exchange tube set 1013 is inserted through the through-holes of the material-guiding spiral plate 1012, and uniformly arranged inside the cylinder 1011; the cylinder 1011 is externally covered with an insulation layer;
a feed device 102 and a discharge device 103, respectively arranged at ends of the drum cylinder 101;
a support roller device 104, arranged at the bottom of the drum cylinder near a discharge device end of the drum cylinder 101;
a retaining roller device 105, arranged at the bottom of the drum cylinder near a feed device end of the drum cylinder 101;
a transmission device 106, arranged at the support roller device 104; the drum cylinder 101 is supported by the support roller device 104 and the retaining roller device 105, and can perform continuous rotary motion under the drive of the transmission device 106.

The heat exchange tube set is uniformly arranged inside the cylinder.

Preferably, the cylinder 1011 of the drum cylinder 101 is composed of three sections, which are made of heat-resistant stainless steel, stainless steel, and alloy steel, respectively, forming a high temperature section, a medium temperature section, and a low temperature section in sequence.

Preferably, the transmission device 106 is composed of a main transmission system and an auxiliary transmission system that are mutually self-locking, wherein a main motor of the main transmission system adopts a variable-frequency speed-regulating motor.

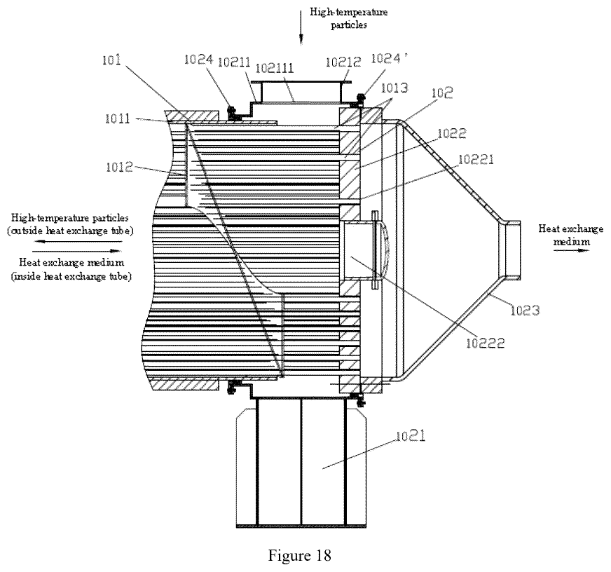

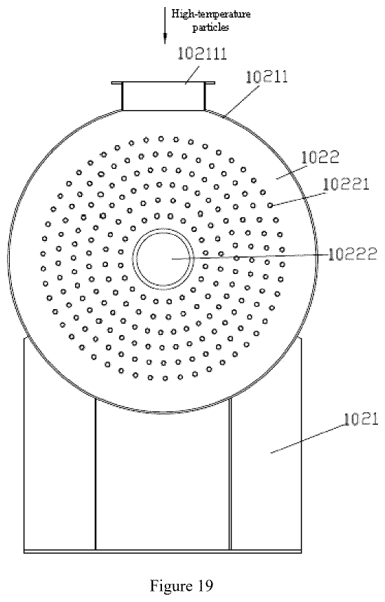

Referring to FIGS. 18 and 19, the feed device 102 of the present invention comprises:
a first fixed base 1021, a first connecting tube body 10211 is arranged on the upper part of the first fixed base; one end of the cylinder 1011 of the drum cylinder 101 is inserted into one end of the first connecting tube body 10211 of the first fixed base 1021, with a clearance fit between them and sealed by a sealing device 1024; the top of the tube body 10211 is equipped with an inlet 102111 and a discharge connecting tube 10212; preferably, the distance L between the drum cylinder 1011 extending into the first connecting tube body 10211 of the first fixed base 1021 and the centerline of the discharge connecting tube 10212 is half of the radius of the inlet of the discharge connecting tube 10212;
a first blocking plate 1022, inserted into the other end of the first connecting tube body 10211 of the first fixed base 1021, with a clearance fit between them and sealed by the sealing device 1024′; several fixing holes 10221 are arranged on the first blocking plate 1022 for the heat exchange tube set 1013 to pass through, and one end of the heat exchange tube set 1013 is welded to the first blocking plate 1022; preferably, a manhole 10222 is arranged at the center of the first blocking plate 1022;
a first rotating connecting pipe 1023, fixedly connected to the first blocking plate 1022 through a flange.

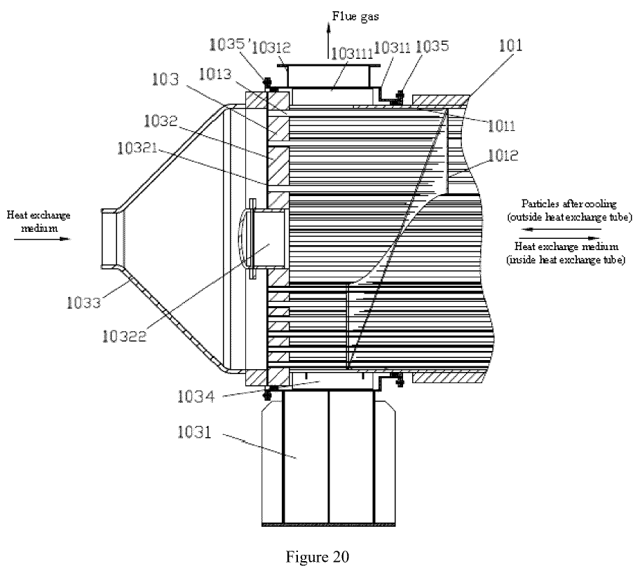

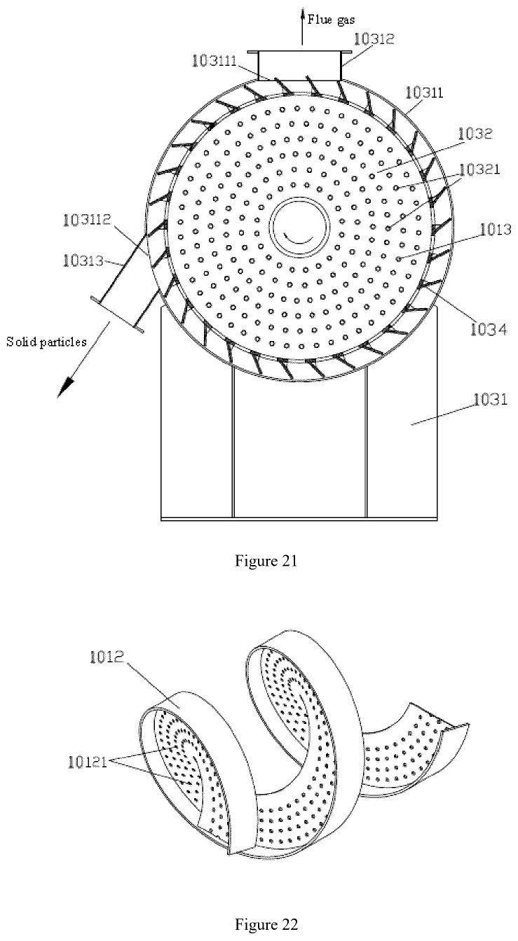

Referring to FIGS. 20 and 21, the discharge device 103 of the present invention comprises:
a second fixed base 1031, wherein a second connecting tube body 10311 is arranged on the upper part of the second fixed base; the other end of the cylinder 1011 of the drum cylinder 101 is inserted into one end of the second connecting tube body 10311 of the second fixed base 1031, with a clearance fit between them and sealed by the sealing device 1035; the top of the second connecting tube body 10311 is equipped with a flue gas outlet 103111 and a flue gas connecting pipe 10312; a discharge outlet 103112 and a corresponding discharge pipe 10313 are arranged on one side of the middle or lower part of the second connecting tube body 10311; preferably, the discharge pipe 10313 is arranged tangentially along the circumference of the second connecting tube body 10311;
a second blocking plate 1032, inserted into the other end of the second connecting tube body 10311 of the second fixed base 1031, with a clearance fit between them and sealed by the sealing device 1035′; several fixing holes 10321 are arranged on the second blocking plate 1032 for the heat exchange tube set 1013 to pass through, and the other end of the heat exchange tube set 1013 is welded to the second blocking plate 1032; preferably, a manhole 10322 is arranged at the center of the second blocking plate 1032;
a second rotating connecting pipe 1033, fixedly connected to the second blocking plate 1032 through a flange;
several scrapers 1034, scrapers are uniformly arranged along the inner wall circumference of the drum cylinder 1011 in the drum cylinder 1011 within the second connecting pipe 10311; preferably, an angle between the scraper 1034 and the tangential direction of the circumference of the drum cylinder 101 is 40-50°; one end of the scraper 1034 is welded to the drum cylinder 101, and the other end is welded and connected to the second blocking plate 1032.

Preferably, the length of the material-guiding spiral plate extending outside the drum cylinder is 100-200 mm.

Preferably, the distance between end of the drum cylinder extending into the second connecting pipe and the second blocking plate 32 is 500-800 mm.

During operation, the horizontally arranged drum cylinder is supported by the support roller device and the retaining roller device and can perform the continuous rotary motion under the drive of the main transmission system of the transmission device. The rotation of the drum cylinder drives the rotation of the material material-guiding spiral plate 32, which in turn drives the high-temperature solid particles to move from right to left in the gap between the inner wall of the drum cylinder and the outer surface of the heat exchange tubes. The heat exchange medium flows from left to right inside the heat exchange tubes, ensuring that the high-temperature solid particles and the heat exchange medium do not come into direct contact, meeting the requirements of indirect heat transfer and exchange.

The main transmission system and the auxiliary transmission system of the transmission device are mutually self-locking, that is, when the main transmission system is activated, the auxiliary transmission system cannot be activated, and vice versa. The main transmission system is activated during operation, but the auxiliary transmission system cannot be activated. The auxiliary transmission system is only activated when the drum cylinder is under maintenance, or the main motor is powered off.

### Example 11

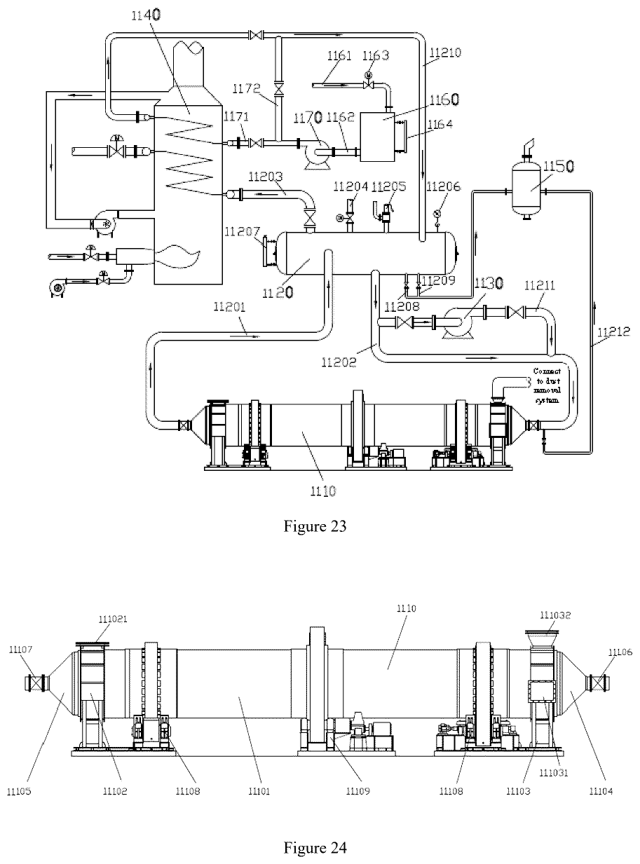

Referring to FIGS. 23 to 26, another recuperative waste heat recovery system for high-temperature solid slag particles of the present invention is further illustrated, comprising:

a heat exchanger 1110, comprising:
a heat exchange cylinder 11101, a feed box 11102, a discharge box 11103, and corresponding inlet 111021, discharge outlet 111031, and flue gas outlet 111032 are arranged at both ends of the heat exchange cylinder;
a water header 11104 and a steam-water header 11105, respectively arranged at the ends of the discharge box 11103 and the feed box 11102 of the heat exchange cylinder 11101;
a water inlet rotary joint 11106 and a steam outlet rotary joint 11107, respectively arranged at the outer ends of the water header 11104 and steam-water header 11105 on the heat exchange cylinder 11101;
twin support-retaining roller devices 11108, arranged on both sides of the heat exchange cylinder 11101;
a rotary drive device 11109, arranged below the middle part of the heat exchange cylinder 11101;
a steam drum 1120, an ascending pipe 11201, a downcomer 11202, a steam outlet pipe 11203, a vent pipe 11204, a safety valve 11205, a pressure gauge 11206, a water level gauge 11207, a steam drum blowdown pipe 11208, an emergency water discharge pipe 11209, and a water inlet pipe 11210; wherein
the steam drum 1120 is connected to the steam outlet rotary joint 11107 of the heat exchanger 1110 through the ascending pipe 11201, and is connected to the water inlet rotary joint 11106 of the heat exchanger 1110 through the downcomer 11202; the heat exchanger 1110 and the steam drum 1120 form a closed circulatory system; the downcomer 11202 is connected in parallel with a booster pipe 11211, and a booster pump 1130 is arranged on the booster pipe 11211 to provide auxiliary power for the steam-water circulation flowing through the booster pump 1130;
a superheater 1140, sequentially equipped with a preheating module 1141, a superheating module 1142, and a combustion module 1143 from top to bottom; the steam drum 1120 is connected to the preheating module 1141 through the water inlet pipe 11210 and to the superheating module 1142 through the steam outlet pipe 11203;
a blowdown expansion vessel 1150, a heat exchanger blowdown pipe 11212 is arranged on the end of the downcomer 11202 of the steam drum 1120 and the water inlet rotary joint 11106 of the heat exchanger 1110, the heat exchanger blowdown pipe 11212 of heat exchanger is connected to the blowdown expansion vessel 1150;
a water tank 116, equipped with a liquid level gauge 1164, the inlet pipeline of water tank is equipped with an electric regulating valve 1163, and the outlet pipeline of water tank is connected to the inlet of the water supply pump 1170; the outlet pipeline 1171 of the water supply pump 1170 is connected to the water inlet 11411 of the preheating module 1141 of the superheater 1140; the water outlet 11412 of the preheating module 1141 is connected to the steam drum 1120 through the water inlet pipe 11210 of the steam drum 1120; a bypass pipe 1172 is arranged between the outlet pipeline 1171 of the water supply pump 1170 and the inlet pipeline 11210 of the steam drum 1120; when the superheater 1140 is under maintenance due to a fault, the preheating module 1141 of the superheater 1140 can be short circuited through the bypass pipe 1172; the liquid level gauge 1164 of the water tank is interlocked with the electric regulating valve 1163 on the inlet pipeline, adjusting the water supply volume of the water tank based on the liquid level of the water tank, ensuring the water volume in the water tank and preventing water shortage accidents.

Continuous spiral support tube sheets 111013 are welded on the inner wall of the heat exchange cylinder 11101, the continuous spiral support tube sheets 111013 are distributed in a spiral shape along an axis direction inside the heat exchange cylinder 11101; corresponding through-holes are arranged on the spiral support tube sheet cylinder, and several heat exchange tubes 111014 are inserted into the through-holes of the spiral support tube sheet 111013; both ends of the heat exchange cylinder 11101 are equipped with flange tube sheets 111015, and both ends of the heat exchange tube 111014 are respectively fixed to the two flange tube sheets 111015; the two flange tube sheets 111015 are fixedly connected to a steam-water header 11105 and a water header 11104, respectively; one end of the heat exchange tube 111014 is connected to the water header 11104, and the other end of the heat exchange tube 111014 is connected to the steam-water header 11105; the water header 11104 is rotatably connected to the water inlet rotary joint 11106, the steam-water header 11105 is rotatably connected to a steam outlet rotary joint 11107, with graphite material used for sealing at the connection; the steam-water header 11105 and the water header 11104 rotate together with the heat exchanger cylinder 11101.

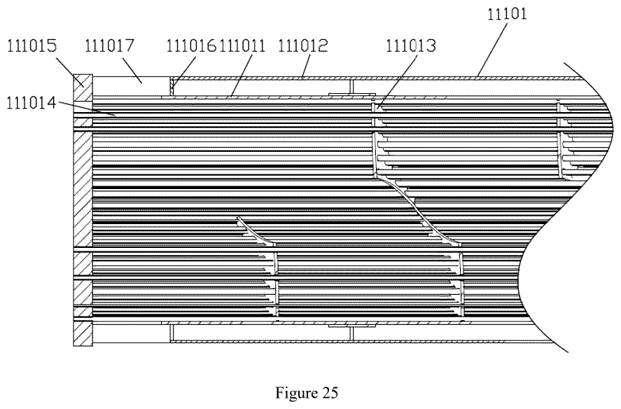

Referring to FIG. 25, the heat exchange cylinder 11101 is equipped with an inner cylinder wall 111011 and an outer cylinder wall 111012, the inner cylinder wall 111011 and several heat exchange tubes 111014 form a heat exchange space, and insulation material is filled between the inner cylinder wall 111011 and the outer cylinder wall 111012; end plates 111016 are arranged at the ends of the inner cylinder wall 111011 and the outer cylinder wall 111012, and several discharge scrapers are welded between the end plates 111016 and flange tube sheet 111015 of the discharge side.

When the heat exchanger 1110 is running, the high-temperature slag enters the heat exchanger cylinder 11101 through the feed box 11102 from the inlet 111021. The rotary drive device 11109 drives the heat exchanger drum 11101 to rotate and provides forward power for the high-temperature slag through the spiral support tube sheet 111013 inside the heat exchanger cylinder 11101. When the high-temperature slag reaches the discharge box 11103, it is lifted to the discharge outlet 111031 through the discharge scrapers 111017 and discharged from the heat exchanger 1110 through the discharge outlet 111031.

The top of the steam drum 1120 is equipped with a safety valve 11205 and a pressure gauge 11206 for detecting the pressure inside the steam drum and ensuring safe use of the steam drum. When the pressure of the steam drum exceeds the upper limit of the working pressure, opening the valve on the vent pipe 11204, reducing the pressure of the steam drum to the working pressure, and then closing the valve on the vent pipe 11204.

The bottom of the steam drum 1120 is equipped with a steam drum blowdown pipe 11208 and an emergency water discharge pipe 11209. The emergency water discharge pipe 11209 merges with the steam drum blowdown pipe 11208 and is connected to the blowdown expansion vessel 1150. The side wall of the steam drum is equipped with a water level gauge 11207, which is used to detect the water level inside the steam drum. When the water level in the steam drum exceeds the upper limit of the safe water level, opening the valve on the emergency water discharge pipe and quickly lowering the water level to the safe range. When the water level in the steam drum is lower than the lower limit of the safety water level, the system stops working to ensure safe operation.

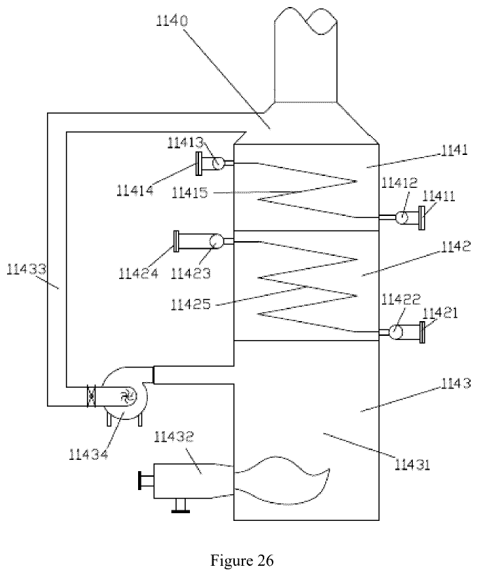

Referring to FIG. 26, the superheater 1140 is sequentially arranged a preheating module 1141, a superheating module 1142, and a combustion module 1143 from top to bottom.

The combustion module 1143 comprises a furnace 11431, a burner 11432, a flue gas circulating pipeline 11433, and a circulating fan 11434; fuel gas and air are sprayed out from the burner 11432 and fully mixed and burned in the furnace 11431 to produce high-temperature flue gas. The high-temperature flue gas is mixed with the low-temperature flue gas drawn back by the circulating fan 11434 to form medium-high-temperature flue gas, which flows upward to the superheating module 1142. The circulating fan 11434 adjusts the reflux rate of the flue gas in the flue gas circulating pipeline 11433, thereby adjusting the temperature of the flue gas entering the superheating module 1142, ensuring that the output superheated steam meets the process requirements.

The superheating module 1142 comprises a steam inlet 11421, a steam inlet header 11422, a steam outlet header 11423, a steam outlet 11424, and a superheater tube set 11425.

The steam outlet tube 11203 of the steam drum 1120 is connected to the steam inlet 11421 of the superheating module 1142. The saturated steam in the steam drum 1120 is transported to the steam inlet header 11422 through the steam inlet 11421 of the superheating module 1142. The saturated steam is uniformly distributed to the superheating tube set 11425 by the steam inlet header 11422. The medium-high-temperature flue gas generated by the combustion module 1143 flows upward through the superheating module 1142, heating the saturated steam in the superheating tube set 11425 into superheated steam. The superheated steam is collected through the steam outlet header 11423 and then connected to the pipeline through the steam outlet 11424 on the steam outlet header of the superheating module for user use. After heat exchange, the temperature of the flue gas decreases and continues to flow towards the preheating module 1141.

The preheating module 1141 comprises a water inlet 11411, a water inlet header 11412, a water outlet header 11413, a water outlet 11414, and a preheating tube set 11415.

The outlet pipeline 1171 of the water supply pump is connected to the water inlet 11411 of the preheating module 1141. The cold water in the water tank 1160 is transported to the water inlet header 11412 of the preheating module 1141 through the water inlet 11411 of the preheating module 1141. The cold water is uniformly distributed to the preheating tube set 11415 through the water inlet header 11412. The flue gas after heat exchange in the superheating module 1142 flows upward through the preheating module 1141, heating the cold water in the preheating tube set 11415 to 90 °C, which is then collected by the water outlet header 11413 of the preheating module 1141, and the water outlet 11414 on the water outlet header 11413 is connected to the water inlet pipe 11210 of the steam drum 1120, delivering hot water into the steam drum 1120.

The working process of Example 11 is as follows:

The water supply pump 1170 delivers cold water in the water tank 1160 to the preheating module 1141 of the superheater 1140 through a pipeline. The cold water is preheated by the preheating module 1141 of the superheater 1140 and becomes hot water, which is then sent to the steam drum 1120 through a steam drum water inlet pipe 11210. The hot water is sent to the water inlet rotary joint 11106 of the heat exchanger through the downcomer 11202, and the water header 11104 uniformly distributes the hot water into the heat exchange pipe 111014. The high-temperature slag continuously enters the heat exchanger 1110 through the inlet 111021, and the heat exchanger 1110 rotates continuously. The spiral support tube sheet 111013 transports the high-temperature slag to a discharge end. During this process, the high-temperature slag continuously contacts with the heat exchange tubes 111014, and the hot water in the heat exchange tubes 111014 absorbs the heat carried by the high-temperature material, turning into high-temperature water and saturated steam; due to the decrease in density, there is a density difference with the hot water in the downcomer 11202, and the high-temperature water and saturated steam then enter the steam drum 1120 through the ascending pipe 11201. The high temperature water and saturated steam are separated in the steam drum 1120. The saturated steam is transported to the superheating module 1142 of the superheater 1140 through the steam drum outlet pipe 11203, where it is heated into superheated steam and sent out for external use. The high temperature water enters the steam drum 1120 and returns to the heat exchanger 1110 through the downcomer 11202, continuing to the heat absorption cycle. The slag after heat exchange is discharged from the heat exchanger 1110 through the discharge outlet 111031. The slag dust and flue gas generated in the heat exchanger 1110 are sent to the dust removal system through the flue gas outlet 111032.

The above descriptions are only preferred specific embodiments of the present invention, the scope protection scope of the present invention is not limited to this. Within the technical scope disclosed in the present invention, the equivalent substitution or modification made by any skilled person familiar with the technical field based on the technical solutions and inventive concepts disclosed in the present invention shall fall within the protection scope of the present invention.

1. A recuperative waste heat recovery system for high-temperature solid slag particles, comprising:
a granulating device being preferably a gas-quenching granulating device, a gas-water granulating device, or a rotary cup granulating device;
a rolling recuperative heat exchanger comprising a slag particle inlet corresponding to a slag outlet of the granulating device, a slag particle outlet, and a heat exchange tube set located inside the recuperative heat exchanger, wherein the heat exchange tube set has a cooling medium inlet and a cooling medium outlet, and the cooling medium is preferably water; and
a waste heat recovery equipment, wherein the cooling medium inlet and the cooling medium outlet are respectively connected to the waste heat recovery equipment through pipelines.

2. The recuperative waste heat recovery system for high-temperature solid slag particles according to claim 1, wherein the waste heat recovery equipment comprises:
a steam drum comprising a steam drum water inlet, a steam drum water outlet, a saturated steam outlet and a steam-water mixture inlet;
a water tank;
wherein, the steam drum water inlet is connected to the water tank, the cooling medium inlet is connected to the steam drum water outlet, and the cooling medium outlet is connected to the steam-water mixture inlet.

3. The recuperative waste heat recovery system for high-temperature solid slag particles according to claim 1, further comprising a conveyor and a dust collector arranged below the slag particle outlet, wherein an inlet end of the dust collector is connected to an air outlet of the recuperative heat exchanger through a pipeline, and an outlet of the dust collector is connected to the waste heat recovery equipment through a pipeline.

4. The recuperative waste heat recovery system for high-temperature solid slag particles according to claim 1, wherein the heat exchanger comprises a cylinder of metal shell-and-tube structure, the slag particle inlet and the slag particle outlet are respectively arranged on a side wall of the cylinder on the cooling medium outlet side and a side wall of the cylinder on the cooling medium inlet side; a spiral plate with interconnected through-holes is arranged inside the cylinder, and the heat exchange tubes are inserted into the through-holes; preferably, an outer shell of the cylinder adopts a water-cooled wall structure, comprising a cylinder heat exchange tube sleeve, a core-shaft heat exchange tube, a spiral plate arranged inside the cylinder, and a heat exchange tube set passing through the spiral plate.

5. The recuperative waste heat recovery system for high-temperature solid slag particles according to claim 1, wherein the heat exchanger comprises:
a drum cylinder, wherein the slag particle inlet is arranged on a side wall of the drum cylinder near the cooling medium outlet, and the slag particle outlet is arranged on the side wall of the drum cylinder near the cooling medium inlet; the drum cylinder is installed with a downward tilt toward the cooling medium outlet side, allowing the slag particles to move from the slag particle inlet to the slag particle outlet; preferably, the drum cylinder is composed of an inner cylinder, an outer cylinder, and insulation material between the inner cylinder and the outer cylinder;
multiple lifting plates arranged at intervals on an inner wall of the drum cylinder along a circumferential direction of the inner wall of the drum cylinder, wherein the lifting plates are L-shaped;
a cylinder drive device comprising a gear ring, a driving motor and a support structure arranged outside of the drum cylinder, wherein the cylinder drive device is used to roll the drum cylinder; wherein,
the heat exchange tube set is arranged in the center of the drum cylinder, on the inner wall of the drum cylinder, and on the inner side of the lifting plates.

6. The recuperative waste heat recovery system for high-temperature solid slag particles according to claim 5, wherein the heat exchange tube set comprises an A-type heat exchange tube set and a B-type heat exchange tube set, multiple fins are vertically arranged on an outer wall of the A-type heat exchange tube set in the circumferential direction to form a finned tube, the A-type heat exchange tube set is located in the center of the drum cylinder, and the fins are preferably ring ribs, column ribs, or plate ribs; the B-type heat exchange tube set is arranged on the lifting plates or the inner wall of the drum cylinder.

7. The recuperative waste heat recovery system for high-temperature solid slag particles according to claim 6, wherein the heat exchange tube set is arranged in the drum cylinder by adopting multiple tube passes, and the number of the tube passes is odd; preferably, the flow resistances of each heat exchange tube are consistent.

8. The recuperative waste heat recovery system for high-temperature solid slag particles according to claim 5, further comprising:
a buffer tank drum having an inlet and an inlet pipeline on one side of its side wall, and a discharge outlet and a discharge pipeline on the other side; the buffer tank drum is installed with a tilt toward the discharge outlet side, ensuring that the slag particles move from an inlet end to a discharge end inside the cylinder;
first material lifting plates vertically arranged at intervals along an inner wall of the buffer tank drum in the circumferential direction, and the first material lifting plates are L-shaped; and
a first drive device comprising a gear ring, a first driving motor, and corresponding support structures arranged on the outer wall of the buffer tank drum.

9. The recuperative waste heat recovery system for high-temperature solid slag particles according to claim 1, wherein the heat exchanger comprises:
a drum cylinder horizontally arranged, wherein a feed device comprising a slag particle inlet and a discharge device comprising a slag particle outlet are arranged at the ends of the drum cylinder;
a material-guiding spiral plate arranged inside the drum cylinder, wherein the material-guiding spiral plate has through-holes for the heat exchange tube set to pass through;
a support roller device arranged at the bottom of the cylinder near a discharge device end of the cylinder;
a retaining roller device arranged at the bottom of the cylinder near a feed device end of the cylinder;
a transmission device arranged at the support roller device; wherein the cylinder is supported by the support roller device and the retaining roller device, and can perform a continuous rotary motion under the drive of the transmission device; wherein
the heat exchange tube set is uniformly arranged inside the cylinder.

10. The recuperative waste heat recovery system for high-temperature solid slag particles according to claim 9, wherein the heat exchanger satisfies one or more of the following:
the cylinder is composed of three sections, respectively made of heat-resistant stainless steel, stainless steel, and alloy steel, forming a high-temperature section, a medium-temperature section and a low-temperature section in sequence;
the transmission device is composed of a main transmission system and an auxiliary transmission system that are mutually self-locking, wherein a main motor of the main transmission system adopts a variable-frequency speed-regulating motor;
a length of the material-guiding spiral plate extending out of the cylinder is 100-200 mm.

11. The recuperative waste heat recovery system for high-temperature solid slag particles according to claim 1, wherein the heat exchanger comprises:
a heat exchanger cylinder equipped with a feed box comprising a slag particle inlet and a discharge box comprising a slag particle outlet at the ends of the heat exchanger cylinder, the ends of the heat exchanger cylinder near the discharge box and the feed box are respectively arranged with a water header and a steam-water header;
twin support-retaining roller devices arranged on both sides of the heat exchanger cylinder;
a rotary drive device arranged at the bottom of the middle part of the heat exchanger cylinder; wherein,
the steam drum and the heat exchanger form a closed circulatory system;
the waste heat recovery equipment comprises a superheater, which is sequentially equipped with a preheating module, a superheating module, and a combustion module from top to bottom; the steam drum is connected to the preheating module through a water inlet pipe and connected to the superheating module through a steam outlet pipe;
a blowdown pipe and an emergency water discharge pipe are arranged at the bottom of the steam drum, and the blowdown pipe and the emergency water discharge pipe are connected to a blowdown expansion vessel;
a regulating valve preferably an electric regulating valve is arranged on an inlet pipeline of the water tank, and an outlet pipeline of the water tank is connected to an inlet of water supply pump, an outlet pipeline of the water supply pump is connected to an inlet of the superheater; preferably, the water tank is equipped with a liquid level gauge.

12. The recuperative waste heat recovery system for high-temperature solid slag particles according to claim 11, wherein the recuperative waste heat recovery system for high-temperature solid slag particles satisfies one or more of the following:
continuous spiral support tube sheets are welded on the inner wall of the heat exchanger cylinder, the continuous spiral support tube sheets are spirally distributed along an axis direction inside the heat exchanger cylinder; corresponding through-holes are arranged on the spiral support tube sheets, and the heat exchange tube set is inserted into the through-holes of the spiral support tube sheets; both ends of the heat exchanger cylinder are equipped with flange tube sheets, and the ends of the heat exchange tube are respectively fixed to the two flange tube sheets, which are fixedly connected to the steam-water header and the water header, respectively; one end of the heat exchange tube is connected to the water header, and the other end of the heat exchange tube is connected to the steam-water header; the water header is rotatably connected to a water inlet rotary joint, the steam-water header is rotatably connected to a steam outlet rotary joint, and the rotating connection is sealed with graphite material; the steam-water header and the water header are rotated together with the heat exchanger cylinder;
the heat exchanger cylinder is equipped with an inner cylinder wall and an outer cylinder wall, the inner cylinder wall and the heat exchange tube form a heat exchange space, and insulation material is filled between the inner cylinder wall and the outer cylinder wall; end plates are arranged on the inner cylinder wall, the outer cylinder wall, and the ends, and discharge scrapers are circumferentially welded between the end plates and the flange tube sheets on the discharge side.

13. The recuperative waste heat recovery system for high-temperature solid slag particles according to claim 12, wherein,
the superheater is sequentially equipped with a preheating module, a superheating module, and a combustion module from top to bottom;
the combustion module comprises a furnace, a burner, a flue-gas circulating pipeline, and a circulating fan;
the superheating module comprises a steam inlet, a steam inlet header, a steam outlet header, a steam outlet, and a superheating tube set;
the steam outlet pipeline of the steam drum is connected to the steam inlet of the superheating module, and the saturated steam in the steam drum is transported into the steam inlet header through the steam inlet of the superheating module, and the saturated steam is uniformly distributed to the superheating tube set by the steam inlet header;
the preheating module comprises a water inlet, a water inlet header, a water outlet header, a water outlet, and a preheating tube set; the outlet pipeline of the water supply pump is connected to the water inlet, and cold water in water tank is transported into the water inlet header through the water inlet, and cold water is uniformly distributed to the preheating tube set by the water inlet header; the flue gas after heat exchange in the superheating module flows upward through the preheating module, heating the cold water in the preheating tube set, after being collected by the water outlet header on the preheating module, a water outlet on the water outlet header is connected to the water inlet pipe of the steam drum, and hot water is transported into the steam drum.

14. The recuperative waste heat recovery system for high-temperature solid slag particles according to any one of claim 1, wherein the heat exchanger comprises a cylinder, the slag particle inlet and the slag particle outlet are respectively arranged at the upper end and bottom of the cylinder, the upper part of one side wall of the cylinder is arranged with an air outlet, and the lower part of the other side wall is arranged with an air inlet pipeline and a fan; preferably, a guide plate that uniformly guides the flow of slag particles is arranged at the upper part inside the cylinder; preferably, the lower part inside the cylinder is equipped with an air distribution equipment.

15. The recuperative waste heat recovery system for high-temperature solid slag particles according to claim 1, wherein the heat exchanger is of a metal shell-and-tube structure, the interior of which is divided into a superheating section and a vaporization section at the top and bottom, a first heat exchange tube set and a second heat exchange tube set are respectively arranged in the superheating section and the vaporization section, wherein an inlet end of the first heat exchange tube set is connected to a saturated steam outlet of the steam drum, and an outlet end of the first heat exchange tube set is connected to a steam pipe network through a pipeline via a buffer tank, an inlet end of the second heat exchange tube set is connected to a saturated water outlet of the steam drum, and an outlet end of the second heat exchange tube is connected to a saturated steam-water mixture inlet of the steam drum, and the heat exchanger is provided with guide plates arranged vertically at intervals and a material distributing chute located below the slag inlet, and through-holes for heat exchange tubes to pass through are arranged on the guide plates.

16. The recuperative waste heat recovery system for high-temperature solid slag particles according to claim 6, further comprising a disturbance rod inserted between the first heat exchange tube and the second heat exchange tube in the heat exchanger with one end of the disturbance rod fixed to a fixed base and the other end of the disturbance rod extending out of the heat exchanger; disturbance arms are arranged at intervals on rod body of the disturbance rod in the axial direction, and an axis of the disturbance arm and an axis of the disturbance rod form an angle; preferably, adjacent disturbance arms are installed in an anti-symmetric manner;
a drive device with an output end of the drive device connected to the end of the disturbance rod extending out of the heat exchanger.

17. The recuperative waste heat recovery system for high-temperature solid slag particles according to claim 7, wherein the drive device is of a worm and worm wheel type, wherein the worm wheel is coaxially connected to the end of the disturbance rod.

18. The recuperative waste heat recovery system for high-temperature solid slag particles according to claim 1, further comprising at least one high-temperature storage tank arranged between the granulating device and the recuperative heat exchanger, wherein an inlet connected to the slag outlet of the granulating device is arranged at the top of the high-temperature storage tank, and an outlet connected to the slag particle inlet of the heat exchanger is arranged at the bottom of the high-temperature storage tank; the lower part of one side wall of the high-temperature storage tank is equipped with an air inlet, an air inlet pipeline, and a fan, while the upper part of the opposite side wall is equipped with an air outlet, which is connected to an inlet end of a dust collector through a pipeline, and an outlet of the dust collector is connected to the waste heat recovery equipment through a pipeline; preferably, a temperature detection device is installed in the pipeline connected to the dust collector; preferably, an air distribution equipment connected to the air inlet pipeline is arranged on the lower part of the high-temperature storage tank; more preferably, a filter screen, insulation material, and an outer shell are arranged on the side wall of the high-temperature storage tank from the inside out.

19. The recuperative waste heat recovery system for high-temperature solid slag particles according to claim 1, wherein the waste heat recovery equipment further comprises a superheater and/or an evaporator, an inlet of the superheater is connected to the saturated steam outlet of the steam drum, and an outlet of the superheater is connected to a steam pipeline network; an inlet of the evaporator is connected to the water tank, and an outlet of the evaporator is connected to the water inlet of the steam drum.

20. The recuperative waste heat recovery system for high-temperature solid slag particles according to claim 19, wherein the superheater and the evaporator are arranged in a sealed container, and an air inlet is arranged on the sealed container and connected to an outlet of a dust collector through a pipeline; an outlet of the sealed container is connected to an air purifier through a pipeline and a fan; preferably, the evaporator and the superheater adopt a coil structure;
preferably, a water treatment device is further comprised between the evaporator and the water tank.

21. The recuperative waste heat recovery system for high-temperature solid slag particles according to claim 1, wherein the gas-quenching granulating device comprises:
a granulating chamber with a box structure, wherein a molten slag flow inlet is arranged at the top of the granulating chamber, and a molten slag chute is arranged above the molten slag flow inlet; a slag particle flow outlet is arranged at the bottom of the granulating chamber;
a high-pressure nozzle arranged on the side wall of the granulating chamber, wherein an outlet of the high-pressure nozzle faces the molten slag flow inlet, and an air outlet, a dust collector, and a fan are arranged at the upper part of the other side wall of the granulating chamber; preferably, the high-pressure nozzle is a Laval nozzle.

22. The recuperative waste heat recovery system for high-temperature solid slag particles according to claim 1, wherein the gas-water granulating device comprises:
a granulating chamber with a box structure, wherein a molten slag flow inlet is arranged at the top of the granulating chamber, and a molten slag chute is arranged above the molten slag flow inlet; a slag particle flow outlet is arranged at the bottom of the granulating chamber;
a high-pressure nozzle arranged on the side wall of the granulating chamber, wherein an outlet of the high-pressure nozzle faces the molten slag flow inlet, and a gas-water outlet, a filter, a gas-water separator, and a fan are arranged at the upper part of the other side wall of the granulating chamber, and the high-pressure nozzle is an atomizing nozzle or a gas-liquid dual-fluid nozzle.

23. The recuperative waste heat recovery system for high-temperature solid slag particles according to claim 1, wherein the rotary cup granulating device comprises:
a granulating chamber with a box structure, wherein a molten slag flow inlet is arranged at the top of the granulating chamber and a molten slag flow outlet is arranged at the bottom, an air inlet, an air inlet pipeline, and a fan are arranged at the lower part of one side wall of the granulating chamber, and an air outlet, an air outlet pipeline, a dust collector, and a fan are arranged on the upper part of the other side wall of the granulating chamber;
a rotating motor arranged at the center of the granulating chamber; and
a rotary cup arranged at an output end of the rotating motor.

24. A recuperative waste heat recovery method for high-temperature solid slag particles, comprising the following steps:
a) introducing molten slag into a granulating device for molten slag granulating treatment to obtain slag particles, air in the molten slag granulating process performs a contact heat exchange with the molten slag and is discharged through a dust collector and a fan; preferably, the molten slag granulating treatment adopts gas-quenching granulating, gas-water granulating or rotary cup granulating;
b) introducing the slag particles into a rolling recuperative heat exchanger, where the slag particles perform an indirectly contact heat exchange with water or steam from a steam drum through a heat exchange tube set, and the water or steam absorbs heat to generate high-temperature water, saturated steam, or superheated steam;
c) sending the heat-exchanged slag particles out through a conveyor.

25. The recuperative waste heat recovery method for high-temperature solid slag particles according to claim 24, wherein the method satisfies at least one of the following:
in step b), the slag particles perform indirectly contact heat exchange with water or steam from the steam drum through the heat exchange tube set and/or a cylinder heat exchange tube sleeve and a core-shaft heat exchange tube; the heat-exchanged slag particles are pushed down to the conveyor by a spiral plate and discharged through the conveyor;
in step b), the slag particles uniformly fall under the action of guide plates of the recuperative heat exchanger, coming into contact with air blown out by an air distribution equipment arranged at the lower part of the recuperative heat exchanger during the falling process to exchange heat with air;
in step b), saturated water from the steam drum enters a second heat exchange tube of a vaporization section of the recuperative heat exchanger, becoming a saturated water-steam mixture after heat exchange with the high-temperature slag particles, which is then returned to the steam drum through a pipeline to achieve steam water separation; the saturated steam in the steam drum flows into a first heat exchange tube of a superheating section of the recuperative heat exchanger under the pressure difference, and forms a superheated steam after heat exchange with the slag particles, and then is connected to a steam pipe network through a buffer tank via a pipeline; preferably, when the slag flow rate is lower than a set value, the steam pipeline of the superheating section is closed;
before step b), the slag particles first enter a high-temperature storage tank for temporary storage, and then enter the recuperative heat exchanger; during the temporary storage of the slag particles in the high-temperature storage tank, hot air generated in the high-temperature storage tank is sent to a waste heat recovery equipment for heat exchange after being dedusted by a dust collector; preferably, multiple high-temperature storage tanks are adopted and arranged in parallel.

26. (canceled)

27. (canceled)

28. (canceled)
